(19) United States
(12) Patent Application Publication
(10) Pub. No.: US 2025/0360405 A1
(43) Pub. Date: Nov. 27, 2025

(54) Virtual Battle Display Methods and Systems

(71) Applicant: Tencent Technology (Shenzhen) Company Limited, Shenzhen (CN)

(72) Inventor: Siying Luo, Shenzhen (CN)

(21) Appl. No.: 19/292,134

(22) Filed: Aug. 6, 2025

Related U.S. Application Data
(63) Continuation of application No. PCT/CN2024/096948, filed on Jun. 3, 2024.

(30) Foreign Application Priority Data
Jul. 31, 2023 (CN) 2023109548843

(51) Int. Cl. A63F 13/52; A63F 13/56; A63F 13/58; A63F 13/837

(52) U.S. Cl. CPC A63F 13/52; A63F 13/56; A63F 13/58; A63F 13/837; A63F 2300/8082

(57) ABSTRACT

Virtual battle display methods and systems are described herein, and relate to the field of human-computer interaction. Techniques may include receiving a battle start operation, displaying a battle image of a virtual battle in response to the battle start operation, and displaying battle animations respectively corresponding to n battle regions. There may be at least two teams, each with one or more virtual characters. Each of the n battle regions may include at least one virtual character from each team. The number of battle regions displayed may be based on a depth of field of the virtual battle area.

### CROSS-REFERENCE TO RELATED APPLICATIONS

This application is a Continuation of PCT Application No. PCT/CN2024/096948, filed Jun. 3, 2024, which claims priority to Chinese Patent Application No. 202310954884.3, filed Jul. 31, 2023, each entitled “Virtual Battle Display Method and Apparatus, Device, Medium, and Program Product” each of which is incorporated by reference in its entirety.

### FIELD

Aspects described herein relate to the field of human-computer interaction, and in particular, to a virtual battle display method and apparatus, a device, a medium, and a program product.

### BACKGROUND

An arena game includes a multiplayer battle game. The multiplayer battle game is a game in which two battle parties respectively select at least two virtual characters for battling.

In the related art, in a battle of the multiplayer battle game, a player A selects a virtual character 1 and a virtual character 2 for play, a player B selects a virtual character 3 and a virtual character 4 for play, and then the four virtual characters perform a mixed battle on a same field. Each character may attack all enemy characters on the field at the same time.

However, in the foregoing manner in which a plurality of virtual characters perform a mixed battle, attacks between all virtual characters selected by a player and enemy virtual characters are chaotic, and efficiency of the player in controlling the battle in the multiplayer battle game is low.

### SUMMARY

Aspects described herein provide a virtual battle display method and apparatus, a device, a medium, and a program product, which can improve efficiency of a player in controlling a virtual battle. The technical solutions are as follows:

According to an aspect, a virtual battle display method is provided. The method is performed by a computer device, and includes:
receiving a battle start operation, the battle start operation being configured for starting a virtual battle, and the virtual battle being a battle between a plurality of first virtual characters and a plurality of second virtual characters;
displaying a battle image of the virtual battle in response to the battle start operation, the battle image including n battle regions, the n battle regions being regions obtained through division based on a depth of field range of the battle image, an i^{th} battle region including at least one first virtual character and at least one second virtual character, n being an integer greater than 1, and 0<i≤n; and
displaying battle animations respectively corresponding to the n battle regions, a battle animation corresponding to the i^{th} battle region including an animation of battling between the first virtual character in the i^{th} battle region and the second virtual character in the i^{th} battle region.

According to another aspect, a virtual battle display apparatus is provided. The apparatus includes:
a receiving module, configured to receive a battle start operation, the battle start operation being configured for starting a virtual battle, and the virtual battle being a battle between a plurality of first virtual characters and a plurality of second virtual characters; and
a display module, configured to display a battle image of the virtual battle in response to the battle start operation, the battle image including n battle regions, the n battle regions being regions obtained through division based on a depth of field range of the battle image, an i^{th} battle region including at least one first virtual character and at least one second virtual character, n being an integer greater than 1, and 0<i≤n.

The display module is further configured to display battle animations respectively corresponding to the n battle regions, a battle animation corresponding to the i^{th} battle region including an animation of battling between the first virtual character in the i^{th} battle region and the second virtual character in the i^{th} battle region.

According to another aspect, a computer device is provided. The computer device includes a processor and a memory. The memory has at least one instruction, at least one program, a code set, or an instruction set stored therein. The at least one instruction, the at least one program, the code set, or the instruction set is loaded and executed by the processor to implement the virtual battle display method according to any one of the foregoing aspects.

According to another aspect, a computer-readable storage medium is provided. The storage medium has at least one instruction, at least one program, a code set, or an instruction set stored therein. The at least one instruction, the at least one program, the code set, or the instruction set is loaded and executed by a processor to implement the virtual battle display method according to any one of the foregoing aspects.

According to another aspect, a computer program product or a computer program is provided. The computer program product or the computer program includes computer instructions. The computer instructions are stored in a computer-readable storage medium. A processor of a computer device reads the computer instructions from the computer-readable storage medium. The processor executes the computer instructions, so that the computer device performs the virtual battle display method according to any one of the foregoing aspects.

The technical solutions provided in the aspects described herein have at least the following beneficial effects.

The battle image of the virtual battle displays a plurality of battle regions obtained through division based on the depth of field range of the image, and the plurality of first virtual characters and the plurality of second virtual characters are dispersedly displayed in the battle regions, so that a battle animation between a first virtual character and a second virtual character included in each battle region is displayed in the battle region. On the one hand, the plurality of first virtual characters and the plurality of second virtual characters may be dispersed in separate battle regions for battling, and a player can obtain a battle status of each virtual character from each battle region, to perform targeted adjustment, so that efficiency of the player in controlling the virtual battle is improved. On the other hand, the battle image is divided into the battle regions based on the depth of field range of the image, and the battle image may be differently displayed, so that the player can focus on one or several battle images, avoiding scattering of a focus of the player caused by indiscriminate display of the plurality of battle regions, and further improving the efficiency of the player in controlling the virtual battle.

### BRIEF DESCRIPTION OF THE DRAWINGS

FIG. 1 is a block diagram of a structure of a computer system according to an illustrative aspect described herein.

FIG. 2 is a schematic diagram of an implementation environment according to an illustrative aspect described herein.

FIG. 3 is a flowchart of a virtual battle display method according to an illustrative aspect described herein.

FIG. 4 is a schematic diagram of division into a battle region in a battle image according to an illustrative aspect described herein.

FIG. 5 is a schematic diagram of division into a battle region in a battle image according to another illustrative aspect described herein.

FIG. 6 is a flowchart of a virtual battle display method according to another illustrative aspect described herein.

FIG. 7 is a schematic diagram of an opponent details interface according to an illustrative aspect described herein.

FIG. 8 is a schematic diagram of a battle image according to an illustrative aspect described herein.

FIG. 9 is a schematic diagram of an animation of casting a starter skill according to an illustrative aspect described herein.

FIG. 10 is a schematic diagram of an animation in which a character wins according to an illustrative aspect described herein.

FIG. 11 is a schematic diagram of an animation in which a character leaves a battle region according to an illustrative aspect described herein.

FIG. 12 is a schematic diagram of an animation in which a character arrives at another battle region according to an illustrative aspect described herein.

FIG. 13 is a flowchart of a virtual battle display method according to still another illustrative aspect described herein.

FIG. 14 is a schematic diagram of a battle image according to another illustrative aspect described herein.

FIG. 15 is a schematic diagram of a battle end interface according to an illustrative aspect described herein.

FIG. 16 is a flowchart of a virtual battle display method according to yet another illustrative aspect described herein.

FIG. 17 is a schematic diagram of an opponent selection interface according to an illustrative aspect described herein.

FIG. 18 is a schematic diagram of a lineup selection interface according to an illustrative aspect described herein.

FIG. 19 is a block diagram of a structure of a virtual battle display apparatus according to an illustrative aspect described herein.

FIG. 20 is a block diagram of a structure of a virtual battle display apparatus according to another illustrative aspect described herein.

FIG. 21 is a block diagram of a structure of a terminal according to an illustrative aspect described herein.

### DETAILED DESCRIPTION

A terminal described herein may be a desktop computer, a laptop computer, a mobile phone, a tablet computer, an e-book reader, a moving picture experts group audio layer III (MP3) player, a moving picture experts group audio layer IV (MP4) player, or the like. An application supporting a virtual scene, for example, an application supporting a three-dimensional virtual scene, is installed and run on the terminal. The application may be any one of a virtual reality application, a third-person shooting (TPS) game, a first-person shooting (FPS) game, a multiplayer online battle arena (MOBA) game, a role-playing game, a turn-based action game, a casual party game, a racing game, and the like. In some aspects, the application may be a standalone application, for example, a standalone three-dimensional game program, or may be a network-connected application.

FIG. 1 is a block diagram of a structure of an electronic device according to an illustrative aspect described herein. The electronic device 100 includes an operating system 120 and an application 122.

The operating system 120 is basic software provided for the application 122 to perform secure access to computer hardware.

The application 122 is an application supporting a virtual scene. In some aspects, the application 122 is an application supporting a three-dimensional virtual scene. The application 122 may be any one of a virtual reality application, a TPS game, an FPS game, an MOBA game, a role-playing game, a turn-based action game, a casual party game, a racing game, and the like. The application 122 may be a standalone application, for example, a standalone three-dimensional game program, or may be a network-connected application.

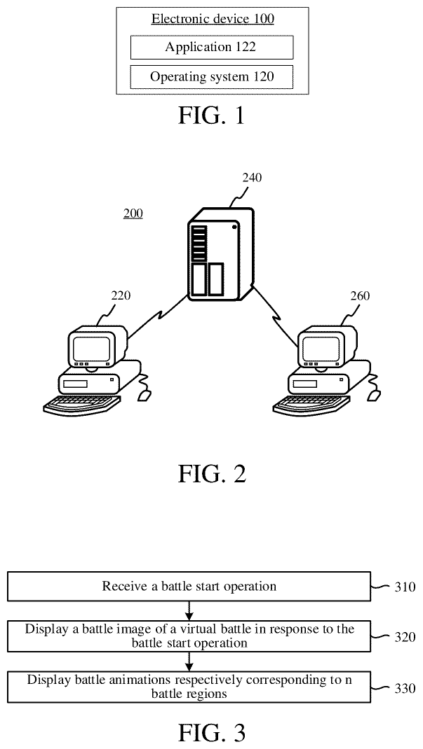

FIG. 2 is a block diagram of a structure of a computer system according to an illustrative aspect described herein. The computer system 200 includes a first device 220, a server 240, and a second device 260.

An application supporting a virtual scene is installed and run on the first device 220. The application may be any one of a virtual reality application, a TPS game, an FPS game, an MOBA game, a role-playing game, a turn-based action game, and the like. The first device 220 is a device used by a first user. The first user uses the first device 220 to control a first virtual character in the virtual scene to perform an action. The action includes but is not limited to at least one of body posture adjustment, crawling, walking, running, cycling, jumping, driving, picking, shooting, attacking, and throwing. For example, the first virtual character is a first virtual human, for example, a simulated human character or a cartoon human character.

The first device 220 is connected to the server 240 by using a wireless network or a wired network.

The server 240 includes at least one of one server, a plurality of servers, a cloud computing platform, and a virtualization center. The server 240 is configured to provide a backend service for an application supporting a three-dimensional virtual scene. In some aspects, the server 240 undertakes main computing work, and the first device 220 and the second device 260 undertake secondary computing work. Alternatively, the server 240 undertakes secondary computing work, and the first device 220 and the second device 260 undertake main computing work. Alternatively, the server 240, the first device 220, and the second device 260 perform collaborative computing by using a distributed computing architecture.

An application supporting a virtual scene is installed and run on the second device 260. The application may be any one of a virtual reality application, a TPS game, an FPS game, an MOBA game, a role-playing game, a turn-based action game, and the like. The second device 260 is a device used by a second user. The second user uses the second device 260 to control a second virtual character in the virtual scene to perform an action. The action includes but is not limited to at least one of body posture adjustment, crawling, walking, running, cycling, jumping, driving, picking, shooting, attacking, and throwing. For example, the second virtual character is a second virtual human, for example, a simulated human character or a cartoon human character.

In some aspects, the first virtual character and the second virtual character are in a same virtual scene. In some aspects, the first virtual character and the second virtual character may belong to a same team, belong to a same organization, have a friend relationship, or have temporary communication permissions. In some aspects, the first virtual character and the second virtual character may alternatively belong to different teams, different organizations, or two groups hostile to each other.

In some aspects, the applications installed on the first device 220 and the second device 260 are the same, or the applications installed on the two devices are a same type of applications of different control system platforms. The first device 220 may generally be one of a plurality of devices, and the second device 260 may generally be one of a plurality of devices. In this aspect, the first device 220 and the second device 260 are used merely as an example for description. A device type of the first device 220 and a device type of the second device 260 may be the same or different. The device type includes at least one of a game console, a desktop computer, a smartphone, a tablet computer, an e-book reader, an MP3 player, an MP4 player, and a laptop computer. In the following aspects, an example in which the device is a desktop computer is used for description.

The server 240 can be an independent physical server, a server cluster or a distributed system including a plurality of physical servers, or a cloud server providing a cloud computing service. A cloud technology is a hosting technology that unifies a series of resources such as hardware, software, and networks in a wide area network or a local area network, to implement calculation, storage, processing, and sharing of data.

In some aspects, a method provided in the aspects described herein may be applied to a cloud game scenario, so that a cloud server completes computing of data logic in a game process, and a terminal is responsible for displaying a game interface.

In some aspects, the server 240 may alternatively be implemented as a node in a blockchain system.

Described herein, before and during collection of relevant data of a user, a prompt interface or a pop-up window may be displayed, or voice prompt information may be outputted. The prompt interface, the pop-up window, or the voice prompt information is configured for prompting the user that the relevant data of the user is currently collected. In this way, described herein, only after a confirmation operation of the user for the prompt interface or the pop-up window is obtained, relevant operations of obtaining the relevant data of the user start to be performed. Otherwise (in other words, when a confirmation operation of the user for the prompt interface or the pop-up window is not obtained), relevant operations of obtaining the relevant data of the user are ended, that is, the relevant data of the user is not obtained. In other words, all user data acquired described herein is acquired with user consent and authorization, and collection, use, and processing of relevant user data need to comply with relevant laws, regulations, and standards of relevant regions.

With reference to the foregoing descriptions and implementation environment, FIG. 3 is a flowchart of a virtual battle display method according to an aspect described herein. Application of the method to a terminal is used as an example. As shown in FIG. 3, the method includes the following operation 310 to operation 330.

Operation 310: Receive a battle start operation.

The battle start operation is configured for starting a virtual battle. The virtual battle is a battle between a plurality of first virtual characters and a plurality of second virtual characters.

In some aspects, the virtual battle is a game battle in a virtual scene in which a plurality of first virtual characters battle a plurality of second virtual characters.

In some aspects, the plurality of first virtual characters are virtual characters controlled by a first terminal, and the plurality of second virtual characters are virtual characters controlled by a second terminal.

In some aspects, an application supporting the virtual scene is run on each of the first terminal and the second terminal.

In some aspects, a first account logs in to the application running on the first terminal, and the plurality of first virtual characters are virtual characters corresponding to the first account. A second account logs in to the application running on the second terminal, and the plurality of second virtual characters are virtual characters corresponding to the second account. For example, a player A logs in, with the first account, to a turn-based action game run on the first terminal, and after logging in, the player A may control the plurality of first virtual characters via the first terminal. A player B logs in, with the second account, to the turn-based action game run on the second terminal, and after logging in, the player B may control the plurality of second virtual characters via the second terminal.

In some aspects, the first terminal is a current terminal (that is, a terminal that currently performs the virtual battle display method), and the second terminal is a terminal other than the current terminal. Alternatively, the second terminal is a current terminal, and the first terminal is a terminal other than the current terminal. This is not limited in this aspect described herein. The following uses an example in which the first terminal is the current terminal for description.

In some other aspects, the plurality of first virtual characters or the plurality of second virtual characters are virtual characters controlled by a system, for example, a non-player character (NPC) or an artificial intelligence (AI) character. In other words, the first virtual character or the second virtual character is not a manually controlled character, but is a character automatically performing an action.

In some other aspects, the plurality of first virtual characters are virtual characters jointly controlled by a first terminal and a system, and the plurality of second virtual characters are virtual characters jointly controlled by a second terminal and the system. In some aspects, a priority of control of the first terminal over the first virtual character is higher than a priority of control of the system over the first virtual character, and a priority of control of the second terminal over the second virtual character is higher than a priority of control of the system over the second virtual character. For example, when the system determines that the first virtual character moves to the left, and the first terminal controls the first virtual character to move to the right, the first virtual character moves to the right.

In some aspects, the first terminal includes a plurality of sub-terminals, the plurality of sub-terminals respectively control one or more first virtual characters, and any one of the plurality of sub-terminals may receive the battle start operation for the virtual battle, or a master terminal in the plurality of sub-terminals receives the battle start operation for the virtual battle, where the master terminal may be one or several sub-terminals in the plurality of sub-terminals. In some aspects, when the plurality of second virtual characters are virtual characters controlled by the second terminal, the second terminal includes a plurality of sub-terminals, and the plurality of sub-terminals respectively control one or more second virtual characters.

In some aspects, the plurality of first virtual characters are virtual characters selected by a first terminal from a plurality of candidate virtual characters.

In some aspects, a character selection interface is displayed, the character selection interface including the plurality of candidate virtual characters. A plurality of specified virtual characters are determined as the plurality of first virtual characters in response to receiving a selection operation on the plurality of specified virtual characters in the plurality of candidate virtual characters.

In some aspects, during or before selection of a character, a player may learn opponent lineup information of a battle opponent, that is, character information corresponding to the plurality of second virtual characters. The character information includes at least one of a character name of the second virtual character, a character avatar, a character skill, a battle sequence of the plurality of second virtual characters, and the like. This is not limited in this aspect described herein. In some aspects, the opponent lineup information is displayed in the character selection interface. Alternatively, an opponent details interface is displayed before the character selection interface is displayed, the opponent details interface including the opponent lineup information.

For example, character information corresponding to a plurality of enemy characters (that is, the second virtual characters) is displayed in the character selection interface, to assist the player in selecting a battle character (that is, the first virtual character), and the player may select, based on a skill counter relationship between characters, a battle character beneficial to a victory for battling.

In some other aspects, the plurality of first virtual characters are virtual characters randomly selected by a system from a plurality of candidate virtual characters. Alternatively, the plurality of first virtual characters are virtual characters selected by a system from a plurality of candidate virtual characters based on opponent lineup information.

In some aspects, after obtaining the plurality of first virtual characters through selection, the system receives a reset operation for the plurality of first virtual characters, displays a plurality of reselected first virtual characters in response to the reset operation, and uses the plurality of reselected first virtual characters as characters for the virtual battle. In some aspects, the plurality of reselected first virtual characters are virtual characters reselected by the system from the plurality of candidate virtual characters, or are virtual characters reselected by a player from the plurality of candidate virtual characters in a character selection interface. The first virtual character is reselected by using the reset operation, so that a problem of poor control efficiency caused by the fact that the first virtual character selected by the system is an unfamiliar virtual character for the player and the player cannot accurately know a trait of the first virtual character due to lack of knowledge when the player controls or arranges the first virtual character selected by the system is solved.

In some aspects, the reset operation may be a character reset operation on the plurality of first virtual characters. For example, the character reset operation means resetting a virtual character a to a virtual character b.

In some aspects, the character reset operation may be a reset operation on all of the plurality of first virtual characters, or the character reset operation is a reset operation on one or several first virtual characters in the plurality of first virtual characters.

In some aspects, the reset operation may alternatively be a battle sequence reset operation for the plurality of first virtual characters. For example, the battle sequence reset operation means resetting a battle sequence of “a virtual character a and a virtual character b” to a battle sequence of “the virtual character b and the virtual character a”.

In some aspects, the battle start operation is an operation triggered by the player in a battle preparation interface.

In some aspects, the character selection interface is displayed in the battle preparation interface as a character selection region. For example, the battle preparation interface includes the character selection region, and after the plurality of first virtual characters for battling are selected, a confirm button in the battle preparation interface may be triggered to start the virtual battle.

Alternatively, the battle preparation interface includes a character selection control, and the character selection interface is displayed after the character selection control is triggered. For example, the battle preparation interface includes the character selection control, the character selection interface is displayed after the character selection control is tapped, and after the plurality of first virtual characters for battling are selected, a confirm button is tapped to directly start the virtual battle.

In some other aspects, the battle start operation is an automatically triggered operation.

In some aspects, the battle start operation is automatically triggered when the virtual battle satisfies a preset starting condition.

The preset starting condition includes at least one of reaching preset time, reaching a preset quantity of characters, and the like.

In some aspects, the character selection interface is displayed, the character selection interface including the plurality of candidate virtual characters. In response to receiving the selection operation on the plurality of specified virtual characters in the plurality of candidate virtual characters, if a quantity of the plurality of specified virtual characters reaches the preset quantity of characters, the plurality of specified virtual characters are determined as the plurality of first virtual characters, and the battle start operation is automatically triggered. For example, after the player determines a battle lineup, that is, determines the plurality of first virtual characters for battling, the virtual battle is automatically started.

Alternatively, if a quantity of the plurality of specified virtual characters reaches the preset quantity of characters, and first time reaches the preset time, the plurality of specified virtual characters are determined as the plurality of first virtual characters, and the battle start operation is automatically triggered. The first time is time from a moment at which the character selection interface is triggered to a current moment. Alternatively, the first time is time from a moment at which the preset quantity of characters is reached to a current moment. For example, the virtual battle is automatically started after three seconds after the player determines the battle lineup.

Operation 320: Display a battle image of the virtual battle in response to the battle start operation.

In some aspects, the battle image is a scene image of a virtual scene including the plurality of first virtual characters and the plurality of second virtual characters. In some aspects, the virtual scene is a three-dimensional virtual scene. Alternatively, the virtual scene is a 2.5-dimensional virtual scene having a longitudinal dimension.

The 2.5-dimensional virtual scene is a representation form of a virtual scene between a two-dimensional virtual scene and a three-dimensional virtual scene. In the 2.5-dimensional virtual scene, a specific three-dimensional effect may be simulated in a manner of overlaying of a plurality of flat layers, layer movement, or the like. For example, it is assumed that the 2.5-dimensional virtual scene includes three flat layers: a foreground layer, a midground layer, and a background layer, and the three layers may be moved in different directions or at different speeds, to simulate the three-dimensional effect.

In addition, different layers represent different depths. For example, if a depth of the foreground layer is small, an image rendered in the foreground image corresponds to a small image range, presented as a large proportion of an element in the image to the layer, and an image rendered in the background layer corresponds to a large image range, presented as a small proportion of an element in the image to the layer, so that a spatial stereoscopic effect is simulated. In other words, in a scene image of the 2.5-dimensional virtual scene, a three-dimensional effect in the longitudinal (that is, Y-axis) dimension may be presented by the plurality of layers.

The battle image includes n battle regions. The n battle regions are regions obtained through division based on a depth of field range of the battle image, and n is an integer greater than 1. In some aspects, the depth of field range corresponding to the battle image is a depth range from a foreground to a background of the battle image.

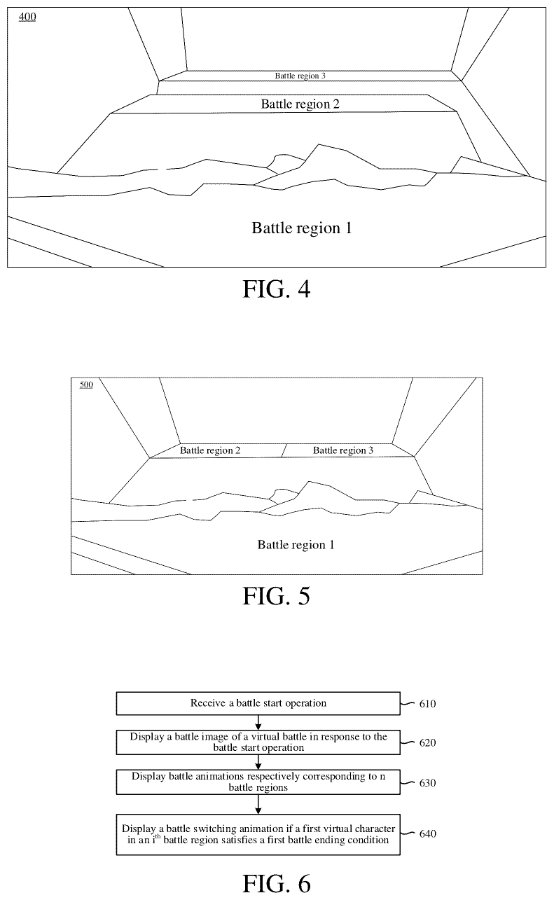

In some aspects, the n battle regions are regions separated from each other. Battles performed in the n battle regions are independent and do not interfere with each other. In some aspects, the n battle regions correspond to n depth ranges, and different battle regions correspond to different depth ranges. For example, FIG. 4 is a schematic diagram of division into a battle region in a battle image. As shown in FIG. 4, a battle image 400 includes a battle region 1, a battle region 2, and a battle region 3. A depth range corresponding to the battle region 1 is smaller than a depth range corresponding to the battle region 2, and the depth range corresponding to the battle region 2 is smaller than a depth range corresponding to the battle region 3.

In some other aspects, the n battle regions correspond to m depth ranges, and m is a positive integer less than n. In other words, there are at least two battle regions corresponding to a same depth of field. For example, at least two battle regions are arranged side by side in a same field of depth range.

For example, FIG. 5 is another schematic diagram of division into a battle region in a battle image. As shown in FIG. 5, a battle image 500 includes a battle region 1, a battle region 2, and a battle region 3. A depth range corresponding to the battle region 1 is smaller than a depth range corresponding to the battle region 2, and the depth range corresponding to the battle region 2 is equal to a depth range corresponding to the battle region 3.

In some aspects, a quantity n of battle regions is determined based on a quantity of the plurality of first virtual characters and a quantity of the plurality of second virtual characters. For example, in a one-on-one case, if there are three first virtual characters and three second virtual characters, it is determined that the quantity of battle regions is three. In a two-on-two case, if there are four first virtual characters and four second virtual characters, it is determined that the quantity of battle regions is two.

Alternatively, a quantity n of battle regions is a preset quantity. In some aspects, if the quantity n of battle regions is the preset quantity, a quantity of the plurality of first virtual characters is set to n, or a quantity of the plurality of first virtual characters is set to an integer greater than n.

An i^{th} battle region includes at least one first virtual character and at least one second virtual character, and 0<i≤n.

In some aspects, when the virtual scene is the three-dimensional virtual scene, the battle image is divided into n battle regions for three-dimensional rendering; or when the virtual scene is the 2.5-dimensional virtual scene, the battle image is divided into n flat layers of different depths for overlay rendering, and an i^{th} flat layer includes the i^{th} battle region.

In some aspects, a battle type in the battle region varies based on a quantity of first virtual characters and a quantity of second virtual characters included in the battle region. The battle type includes at least one of a one-on-one battle, a one-on-many battle (for example, a one-on-two battle), a many-on-many battle (for example, a two-on-two battle and a two-on-three battle), and the like.

For example, refer to FIG. 4. In the battle image 400, in the one-on-one case, the battle region 1 includes a first virtual character a and a second virtual character a′; in the two-on-two case, the battle region 1 includes a first virtual character a, a first virtual character b, a second virtual character a′, and a second virtual character b′; and in a one-on-two case, the battle region 1 includes a first virtual character a, a second virtual character a′, and a second virtual character b′.

In some aspects, the plurality of first virtual characters and the plurality of second virtual characters are randomly allocated to the n battle regions. For example, the system randomly allocates the plurality of first virtual characters and the plurality of second virtual characters, provided that each battle region includes at least one first virtual character and at least one second virtual character.

In some other aspects, the plurality of first virtual characters and the plurality of second virtual characters are allocated to the n battle regions according to a preset allocation policy. The preset allocation policy is a policy for performing character allocation based on a character sequence and a region sequence. The preset allocation policy is customized by the player. Alternatively, the preset allocation policy is set by the system by default.

In some aspects, the plurality of first virtual characters correspond to a first character sequence, the plurality of second virtual characters correspond to a second character sequence, and the n battle regions correspond to the region sequence. The plurality of first virtual characters are sequentially allocated to the n battle regions based on the first character sequence and the region sequence, and the plurality of second virtual characters are sequentially allocated to the n battle regions based on the second character sequence and the region sequence.

For example, in the one-on-one case, if the quantity of the plurality of first virtual characters is n, and the quantity of the plurality of second virtual characters is n, an i^{th} first virtual character and an i^{th} second virtual character are allocated to the i^{th} battle region.

In the two-on-two case, if the quantity of the plurality of first virtual characters is n, and the quantity of the plurality of second virtual characters is n, the first two first virtual characters and the first two second virtual characters are allocated to the 1^{st} battle region.

In the one-on-two case, if the quantity of the plurality of first virtual characters is n, and the quantity of the plurality of second virtual characters is 2n, the first two first virtual characters and the 1^{st} second virtual character are allocated to the 1^{st} battle region.

In some aspects, the first character sequence is a preset sequence, for example, a character sequence determined by the player during selection in the character selection interface. Alternatively, the first character sequence is a sequence determined by the system based on the second character sequence corresponding to the plurality of second virtual characters, for example, a sequence determined by the system based on at least one of a skill counter situation between characters, a character type, a character level, and the like. In some aspects, the region sequence is a sequence determined based on the depth ranges corresponding to the regions. For example, the n battle regions are sorted in ascending order of the depth ranges. Alternatively, the n battle regions are sorted in descending order of the depth ranges.

In some aspects, when a single depth range includes at least two battle regions, a sequence of the at least two battle regions is randomly determined. For example, as shown in FIG. 5, the region sequence may be “the battle region 1, the battle region 2, and the battle region 3”, or may be “the battle region 1, the battle region 3, and the battle region 2”.

In some aspects, in the foregoing battle image rendering process, virtual characters respectively corresponding to the n battle regions may be rendered in the n battle regions after the n battle regions including no virtual characters are rendered.

In some aspects, a battle background image corresponding to the virtual battle is displayed in response to the battle start operation, the battle background image including the n battle regions. A character creation animation is displayed, the character creation animation being an animation of creating the plurality of first virtual characters in the n battle regions. The battle image is displayed after playback of the character creation animation ends. After the virtual battle is started, the battle background image is first rendered on the terminal, and then virtual characters of both battle parties are created in the battle background image. The battle regions and the virtual characters are asynchronously rendered in batches, so that frame freezing caused by rendering a large amount of data at a time is avoided, and image display fluency is improved. For example, after the virtual battle is started, the n battle regions including no virtual characters are first displayed, then characters are created in the n battle regions, and an image that is displayed by the terminal and in which the characters are created is used as the battle image.

In some aspects, the plurality of first virtual characters and the plurality of second virtual characters are created and displayed in the corresponding battle regions. Alternatively, after the plurality of first virtual characters are created and displayed in the corresponding battle regions, the plurality of second virtual characters are created and displayed in the corresponding battle regions. Alternatively, after the plurality of second virtual characters are created and displayed in the corresponding battle regions, the plurality of first virtual characters are created and displayed in the corresponding battle regions. Alternatively, the first virtual characters and the second virtual characters respectively corresponding to the battle regions are created and displayed based on the region sequence of the battle regions. Alternatively, after the first virtual characters respectively corresponding to the battle regions are created and displayed based on the region sequence of the battle regions, the second virtual characters respectively corresponding to the battle regions are created and displayed. For example, after the first virtual character included in the i^{th} battle region is created and displayed in the i^{th} battle region, the second virtual character included in the i^{th} battle region is created and displayed. Alternatively, after the first virtual characters are sequentially created and displayed in the n battle regions, the second virtual characters are created and displayed in the n battle regions.

In some other aspects, in the foregoing battle image rendering process, the first virtual characters for the n battle regions may be rendered in the n battle regions after the n battle regions including no first virtual characters are rendered. In other words, the battle image includes the n battle regions and the plurality of second virtual characters.

In some aspects, a character creation animation is displayed, the character creation animation being an animation of creating the plurality of first virtual characters in the n battle regions. The battle image is displayed after playback of the character creation animation ends. For example, after the virtual battle is started, the n battle regions including the second virtual characters but no first virtual characters are first displayed, then the first virtual characters are created in the n battle regions, and an image that is displayed by the terminal and in which the first virtual characters are created is used as the battle image.

In some aspects, the plurality of first virtual characters are created and displayed in the corresponding battle regions. Alternatively, the first virtual characters respectively corresponding to the battle regions are created and displayed based on the region sequence of the battle regions. In some other aspects, a battle region including a virtual character may be directly rendered in the foregoing battle image rendering process. For example, a battle region and a virtual character corresponding to the battle region are displayed in a binding manner, so that a complete battle image may be directly rendered on a screen of the terminal at a time, that is, the n battle regions and the virtual characters included in the n battle regions are directly displayed. Alternatively, the n battle regions are sequentially rendered on a screen of the terminal based on the region sequence, that is, the n battle regions and the virtual characters included in the n battle regions are sequentially displayed. For example, when the virtual scene is the 2.5-dimensional virtual scene, if the battle image includes the foreground layer (including the battle region 1, the first virtual character a, and the second virtual character a′), the midground layer (including the battle region 2, the first virtual character b, and the second virtual character b′), and the background layer (including the battle region 3, a first virtual character c, and a second virtual character c′), the foreground layer is first rendered, then the midground layer is rendered, and finally the background layer is rendered, where the foreground layer overlays the midground layer, and the midground layer overlays the background layer.

Operation 330: Display battle animations respectively corresponding to the n battle regions.

A battle animation corresponding to the i^{th} battle region includes an animation of battling between the first virtual character in the i^{th} battle region and the second virtual character in the i^{th} battle region.

In some aspects, the battle animations respectively corresponding to the n battle regions are automatically triggered animations.

For example, after the battle image is triggered to be displayed, the virtual battle is started. After the virtual battle is started, the corresponding battle animations are displayed in the battle regions. For example, an animation of battling between the first virtual character a and the second virtual character a′ is displayed in the i^{th} battle region.

The player may control the first virtual character for battling via the first terminal. For example, a skill control is displayed in the battle image, and the skill control is configured for triggering a skill. An animation in which the first virtual character attacks the second virtual character by using the skill is displayed in response to receiving a trigger operation of the player on the skill control.

Alternatively, there is an animation in which the first virtual character automatically performs battling. For example, a skill attack policy is configured for the first virtual character. The skill attack policy includes a skill 1, a skill 2, and a skill 3, where the skill 1 is a starter skill, the skill 2 is an ordinary skill, and the skill 3 is a key skill. The first virtual character attacks the second virtual character by using the skill 1 immediately after the virtual battle is started. Subsequently, the first virtual character continuously attacks the second virtual character by using the skill 2. When a hit point of the second virtual character is less than or equal to a preset hit point, the first virtual character attacks the second virtual character by using the skill 3.

In some aspects, the battle animations respectively corresponding to the n battle regions are displayed. For example, after the first virtual character and the second virtual character in the i^{th} battle region are displayed to start to battle, a first virtual character and a second virtual character in an (i+1)^{th} battle region are displayed to start to battle.

After the virtual battle is started, battles are started in the battle regions at the same time, so that a battle progress of the virtual battle is accelerated, and efficiency of the virtual battle is improved.

After the virtual battle is started, battles are successively started in the battle regions. On the one hand, the battle animations are successively displayed, so that frame freezing caused by rendering a large amount of animation data at a time is avoided, and the image display fluency is improved. On the other hand, there is enough time for the player to pay attention to a battle status of each battle when the virtual battle is started, so that efficiency of the player in controlling the virtual battle is improved.

In some other aspects, the battle image includes a second control for triggering the battle animation. The battle animations respectively corresponding to the n battle regions are displayed in response to receiving a trigger operation on the second control. After the virtual battle is started, the player may control start timing of a battle performed in each battle region by using the second control in the battle image, so that a degree of freedom of the player in controlling the virtual battle during the virtual battle is improved.

In some aspects, there is a single second control. After the second control is triggered, the battle animations respectively corresponding to the n battle regions are displayed at the same time, or the battle animations respectively corresponding to the n battle regions are sequentially displayed based on the region sequence corresponding to the n battle regions.

In some aspects, a long-press operation on the second control is received. A slide operation following the long-press operation is received, a location of a slide starting point of the slide operation being the same as a pressing location of the long-press operation. The battle animation corresponding to the i^{th} battle region is displayed in response to a slide end point indicated by the slide operation being in the i^{th} battle region. After the battle animation corresponding to the i^{th} battle region starts to be played, a battle animation corresponding to another battle region in the n battle regions is displayed. The player may select, by triggering the long-press operation and the slide operation on the second control, a battle region in which a battle is first started, so that fluidity of operations of the player in a battle start control process is improved, and human-computer interaction efficiency is improved.

For example, the player may determine, through the slide operation following the long-press operation on the second control, a battle animation that needs to be first displayed. When the player slides the second control to the i^{th} battle region and stops the slide operation, the i^{th} battle region is used as a region in which a battle is first started, the battle animation corresponding to the i^{th} battle region is displayed, and after the battle animation is played, the battle animation corresponding to the another battle region is displayed.

In some other aspects, the battle image includes a fifth control for pausing the battle animation. Playback of the battle animations respectively corresponding to the n battle regions is paused in response to receiving a trigger operation on the fifth control.

For example, in some cases, for example, when an opponent (that is, the plurality of second virtual characters) of the player is a virtual character controlled by the system, the player may pause a current battle in the battle image by using a pause control (that is, the fifth control).

In summary, according to the virtual battle display method provided in this aspect described herein, after the virtual battle between the plurality of first virtual characters and the plurality of second virtual characters is started, the battle image of the virtual battle displays a plurality of battle regions obtained through division based on the depth of field range of the image, and the plurality of first virtual characters and the plurality of second virtual characters are dispersedly displayed in the battle regions, so that a battle animation between a first virtual character and a second virtual character included in each battle region is displayed in the battle region. On the one hand, the plurality of first virtual characters and the plurality of second virtual characters may be dispersed in separate battle regions for battling, and a player can obtain a battle status of each virtual character from each battle region, to perform targeted adjustment, so that the efficiency of the player in controlling the virtual battle is improved. On the other hand, the battle image is divided into the battle regions based on the depth of field range of the image, and the battle image may be differently displayed, so that the player can focus on one or several battle images, avoiding scattering of a focus of the player caused by indiscriminate display of the plurality of battle regions, and further improving the efficiency of the player in controlling the virtual battle.

In some illustrative aspects, in a battle process of the virtual battle, if a first virtual character in one battle region eliminates a second virtual character, the first virtual character may be moved to another battle region to help another first virtual character. For example, as shown in FIG. 6, the aspect shown in FIG. 3 may alternatively be implemented as the following operation 610 to operation 640.

Operation 610: Receive a battle start operation.

The battle start operation is configured for starting a virtual battle. The virtual battle is a battle between a plurality of first virtual characters and a plurality of second virtual characters.

In some aspects, an opponent details interface is displayed, and the opponent details interface includes opponent lineup information, that is, character information corresponding to the plurality of second virtual characters. The character information includes at least one of a character name of the second virtual character, a character avatar, a character skill, a battle sequence of the plurality of second virtual characters, and the like. This is not limited in this aspect described herein.

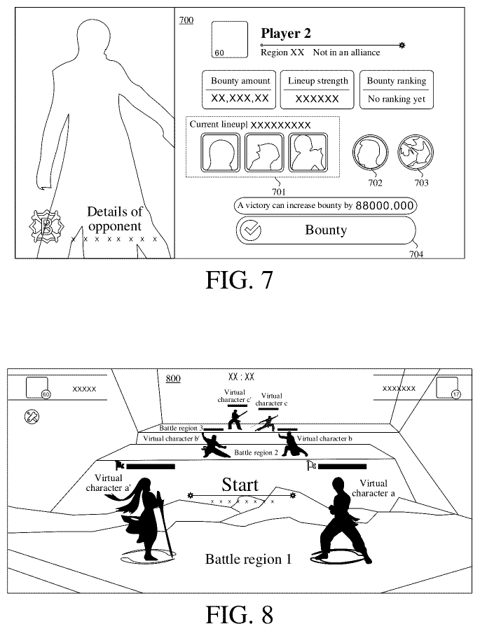

For example, FIG. 7 is a schematic diagram of an opponent details interface. When a player selects to enter a many-on-many virtual battle play method provided by an application, the player may select a virtual character for battling. The virtual character includes a virtual character configured by a system, a virtual character configured by another player, and the like.

When the virtual character is the virtual character configured by the another player, the another player may determine a battle lineup and publish the battle lineup to the application, so that the player may select to perform an asynchronous battle with the virtual character configured by the another player. The asynchronous battle is a battle manner in which the another player is offline and the current player is online. In an asynchronous battle, a virtual character corresponding to an offline player automatically participates in battling under system control.

As shown in FIG. 7, a player 1 selects a player 2 as an opponent. An opponent details interface 700 includes a character lineup 701 configured by the player 2. A battle sequence of characters is “a virtual character a′, a virtual character b′, and a virtual character c′”. A shared skill 702 and a shared skill 703 are configured for the characters. When the player 2 is offline, the shared skill 702 and the shared skill 703 are skills triggered by the system by automatically selecting timing and selecting a character. For example, when a hit point of the virtual character a′ corresponding to the player 2 is less than or equal to a preset hit point, the virtual character a′ is triggered to cast the shared skill 702.

The player 1 may determine a battle character with reference to the character lineup 701, the shared skill 702, and the shared skill 703 that are displayed in the opponent details interface 700. In some aspects, after a “Bounty” control 704 in the opponent details interface 700 is triggered, the player 1 determines to battle the player 2, and a character selection interface is displayed. The player 1 may select a battle character in the character selection interface, and starts the virtual battle after selection.

Operation 620: Display a battle image of the virtual battle in response to the battle start operation.

The battle image includes n battle regions. The n battle regions are regions obtained through division based on a depth of field range corresponding to the battle image. An i^{th} battle region includes at least one first virtual character in the plurality of first virtual characters and at least one second virtual character in the plurality of second virtual characters, n is an integer greater than 1, and 0<i≤n.

In some aspects, the battle image is an image that is acquired via a virtual camera and that has the depth of field range. For example, a foreground of the battle image is an image close to the virtual camera, and a scenery range in the foreground that is framed by the virtual camera is small. A background of the battle image is an image far away from the virtual camera, and a scenery range in the background that is framed by the virtual camera is large.

A depth within a depth range corresponding to a battle region in an image closer to the virtual camera is smaller, and a depth within a depth range corresponding to a battle region in an image farther away from the virtual camera is larger. In other words, division into the battle regions based on the depth of field range corresponding to the battle image is division into the battle regions based on distances to the virtual camera.

For example, division sets a battle image within a distance range of 1 m to 3 m to the virtual camera as a battle region 1, where the distance range may also be understood as a depth range; sets a battle image within a distance range of 4 m to 6 m to the virtual camera as a battle region 2; and sets a battle image within a distance range of 7 m to 8 m to the virtual camera as a battle region 3.

In some aspects, the i^{th} battle region includes one first virtual character in the plurality of first virtual characters and one second virtual character in the plurality of second virtual characters. In some aspects, a quantity n of battle regions is equal to a quantity of the plurality of first virtual characters, and the quantity n of battle regions is equal to a quantity of the plurality of second virtual characters.

In some aspects, the plurality of first virtual characters correspond to a first character sequence, the plurality of second virtual characters correspond to a second character sequence, and the n battle regions correspond to a region sequence. The plurality of first virtual characters are sequentially allocated to the n battle regions based on the first character sequence and the region sequence, and the plurality of second virtual characters are sequentially allocated to the n battle regions based on the second character sequence and the region sequence.

For example, the player 1 may alternatively determine a battle character and a battle sequence of the character in a character selection interface. If the battle character and the battle sequence selected by the player 1 are “a virtual character a, a virtual character b, and a virtual character c”, the quantity n of battle regions is 3.

FIG. 8 is a schematic diagram of a battle image. As shown in FIG. 8, in a battle image 800, the virtual character a and the virtual character a′ perform a one-on-one battle in the battle region 1, the virtual character b and the virtual character b′ perform a one-on-one battle in the battle region 2, and the virtual character c and the virtual character c′ perform a one-on-one battle in the battle region 3.

The battle image 800 is an image acquired by the virtual camera. A distance between the battle region 1 and the virtual camera is less than a distance between the battle region 2 and the virtual camera. The distance between the battle region 2 and the virtual camera is less than a distance between the battle region 3 and the virtual camera.

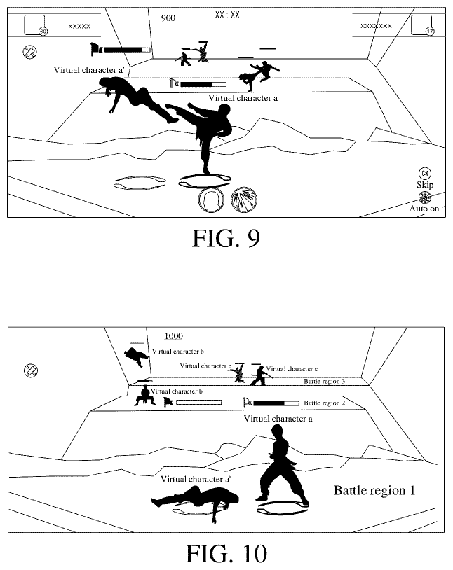

In some aspects, a skill first used by a virtual character is fixed. Therefore, there is a skill counter relationship between two characters. For example, FIG. 9 is a schematic diagram of an animation showing skill countering. As shown in FIG. 9, the 1^{st} skill of the virtual character a′ has characteristics of a high casting speed and a large range, and the 1st skill of the virtual character is fast cast dash attack. Therefore, in a battle image 900, after the virtual characters cast the 1st skills, the 1st skill of the virtual character a may interrupt the 1st skill of the virtual character a′. Based on this, the player may select the character in the character selection interface and determine the battle sequence of the character, for example, arrange the virtual character a to fight against the virtual character a′, or prevent the virtual character a′ from fighting against the virtual character a.

Operation 630: Display battle animations respectively corresponding to the n battle regions.

A battle animation corresponding to the i^{th} battle region is an animation of battling between the first virtual character in the i^{th} battle region and the second virtual character in the i^{th} battle region.

For example, as shown in FIG. 8, after the virtual battle is triggered to be started, the virtual character a, the virtual character b, and the virtual character c, as well as opponents, that is, the virtual character a′, the virtual character b′, and the virtual character c′ are divided into three combinations, to perform one-on-one battles in corresponding battle regions. The three battle regions in FIG. 8 are separated regions, so that the battles performed in the three battle regions are independent and do not interfere with each other.

In some aspects, battle animations displayed in different battle regions correspond to different special effects.

In some aspects, a special effect intensity of a battle special effect in the battle animation corresponding to the i^{th} battle region is determined based on a depth range corresponding to the i^{th} battle region, and the battle animation corresponding to the i^{th} battle region is displayed based on the special effect intensity.

The special effect intensity of the battle special effect is vividness, a detail level, and the like of a special effect generated when the character uses a skill, a prop, and the like for battling. A higher special effect intensity indicates higher rendering resource consumption for image rendering, but indicates better quality of a rendered battle special effect.

In some aspects, the special effect intensity is in negative correlation with the depth range. For example, a smaller depth within the depth range, that is, a shorter distance to the virtual camera, indicates higher special effect intensity, and a larger depth within the depth range, that is, a longer distance to the virtual camera, indicates a lower special effect intensity.

For example, refer to FIG. 8. The battle region 1 is a region closest to the virtual camera, so that a depth within a depth range corresponding to the battle region 1 is minimum. In this case, it is determined that a special effect intensity of the battle region 1 is higher than those of the battle regions 2 and 3. Therefore, battle special effects in the battle region 2 and the battle region 3 may be weakened. For example, a quantity of transmitters is reduced, that is, overall quality of the battle special effects is reduced; and most post-processing effects of the special effects are turned off.

Operation 640: Display a battle switching animation if the first virtual character in the i^{th} battle region satisfies a first battle ending condition.

The battle switching animation is an animation of switching the first virtual character in the i^{th} battle region to a j^{th} battle region in the n battle regions for battling, 0<j≤n, and i≠j. In other words, the j^{th} battle region is another battle region in the n battle regions other than the i^{th} battle region. The animation of switching the first virtual character in the i^{th} battle region to another battle region for battling is displayed if the first virtual character in the i^{th} battle region satisfies the first battle ending condition, so that an association between the battle regions is improved, a battle progress is accelerated, and battle efficiency of the virtual battle is improved.

The first battle ending condition is configured for indicating that the first virtual character in the i^{th} battle region is successful in battling.

In some aspects, the battle switching animation is displayed in response to an attribute value of the second virtual character in the i^{th} battle region being less than or equal to a preset attribute value.

The attribute value includes a hit point, a magic point, a stamina point, and the like. This is not limited in this aspect described herein.

For example, if the preset attribute value is 0, after the second virtual character in the i^{th} battle region is eliminated, the first virtual character in the i^{th} battle region may move to the another battle region to help a teammate battle.

FIG. 10 is a schematic diagram of an animation in which a character wins. As shown in FIG. 10, in a battle image 1000, in the battle region 1, the virtual character a defeats the virtual character a′, and the virtual character a′ is eliminated. The virtual character a′ may move to the battle region 2 to help the virtual character b battle the virtual character b′, or the virtual character a′ may move to the battle region 3 to help the virtual character c battle the virtual character c′.

In some aspects, before the battle switching animation is displayed, a battle region to which the first virtual character in the i^{th} battle region moves needs to be determined, that is, the j^{th} battle region is determined from the another battle region in the n battle regions other than the i^{th} battle region. In some aspects, a method for determining the j^{th} battle region includes at least one of the following methods.

Method 1: Determine a distance between the i^{th} battle region and the another battle region in the n battle regions, determine, from the another battle region, the j^{th} battle region whose distance to the i^{th} battle region meets a distance requirement, and display the battle switching animation.

In some aspects, a battle region in the another battle region whose distance to the i^{th} battle region is minimum is used as the j^{th} battle region. The first virtual character in the i^{th} battle region satisfying the first battle ending condition moves to the battle region closest to the i^{th} battle region for battling, so that efficiency of the first virtual character in participating in battling in the another battle region is improved.

For example, as shown in FIG. 10, a distance between the battle region 1 and the battle region 2 is less than a distance between the battle region 2 and the battle region 3. Therefore, after defeating the virtual character a′, the virtual character a may move to the battle region 2 to help the virtual character b battle the virtual character b′.

Subsequently, in the battle region 2, if the virtual characters a and b jointly defeat the virtual character a′, the virtual characters a and b may move to the battle region 3 to help the virtual character c battle the virtual character c′.

Method 2: Determine an attribute value of a first virtual character in the another battle region other than the i^{th} battle region, determine, from the another battle region, the j^{th} battle region in which an attribute value of a first virtual character meets an attribute value requirement, and display the battle switching animation.

In some aspects, a battle region in the another battle region in which an attribute value of a first virtual character is minimum is used as the j^{th} battle region. The first virtual character in the i^{th} battle region satisfying the first battle ending condition moves to a battle region in which a teammate with a low attribute value is located for battling, so that the battle progress is accelerated, and the battle efficiency of the virtual battle is improved.

For example, if an attribute value of the virtual character b is greater than an attribute value of the virtual character c when the virtual character a defeats the virtual character a′, the virtual character a goes to a battle region 3 to help the virtual character c battle against the virtual character c′.

If the attribute value of the virtual character b is equal to the attribute value of the virtual character c when the virtual character a defeats the virtual character a′, the virtual character a moves to the close battle region 2 to help the virtual character b battle the virtual character b′.

Method 3: Determine a next to-be-cast skill of a second virtual character in the another battle region in the n battle regions, determine, from the another battle region, the j^{th} battle region in which a next to-be-cast skill of a second virtual character satisfies a skill counter requirement, and display the battle switching animation.

In some aspects, a battle region in the another battle region in which a next to-be-cast skill of a second virtual character is countered by a next to-be-cast skill of the first virtual character in the i^{th} battle region is used as the j^{th} battle region.

For example, a next to-be-cast skill of the virtual character b′ has characteristics of a high casting speed and a large range, and a next to-be-cast skill of the virtual character a is a fast cast dash attack. The next to-be-cast skill of the virtual character a may interrupt the next to-be-cast skill of the virtual character b′. Therefore, the virtual character a jumps to a battle region in which the virtual character b′ is located for battling.

In some aspects, the battle switching animation includes a jumping animation in which the first virtual character jumps from the i^{th} battle region to the j^{th} battle region. In some aspects, the jumping animation is displayed if the first virtual character in the i^{th} battle region satisfies the first battle ending condition, the jumping animation being an animation in which the first virtual character in the i^{th} battle region jumps to the j^{th} battle region.

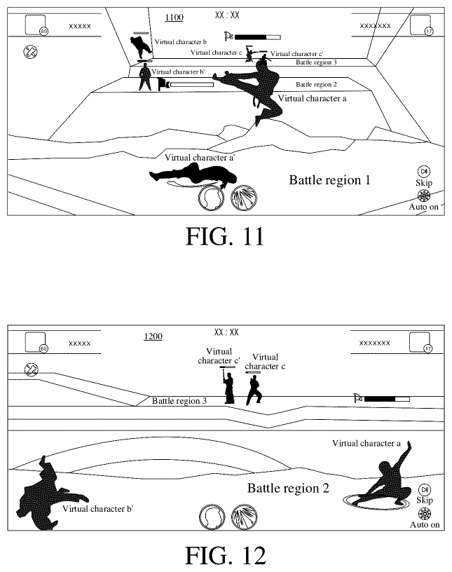

For example, FIG. 11 is a schematic diagram of an animation in which a character leaves a battle region. As shown in FIG. 11, in a battle image 1100, after the virtual character a in the battle region 1 defeats the virtual character a′, a jumping animation in which the virtual character a jumps out of the battle region 1 is displayed.

If the virtual character a moves to the close battle region 2 to help the virtual character b battle the virtual character b′, after playback of the jumping animation ends, the virtual character a is displayed to battle the virtual character b in the battle region 2.

In some aspects, a first camera movement animation of the battle image is displayed if the first virtual character in the i^{th} battle region satisfies the first battle ending condition, the first camera movement animation being configured for adjusting a distance between the j^{th} battle region and the virtual camera.

In some aspects, after the battle switching animation is displayed, that is, playback of the battle switching animation ends, the first camera movement animation of the battle image is displayed.

For example, after the first virtual character in the i^{th} battle region moves to the j^{th} battle region, the distance between the j^{th} battle region and the virtual camera is shortened.

In some aspects, the i^{th} battle region is a region in the n battle regions that is closest to the virtual camera, and the first camera movement animation is configured for moving the i^{th} battle region out of a battle image displayed by a current terminal, and adjusting the j^{th} battle region to a region in the n battle regions that is closest to the virtual camera. When the battle switching animation is displayed, the first camera movement animation of the battle image is displayed, that is, the distance between the j^{th} battle region and the virtual camera is adjusted, so that a focus of the player is transferred to the j^{th} battle region. A depth range of each battle region in the image is dynamically adjusted based on a battle status, so that the focus of the player may be adjusted based on the battle status. Therefore, efficiency of the player in controlling the virtual battle is improved.

For example, as shown in FIG. 11, a battle region currently closest to the virtual camera is the battle region 1. Based on this display sequence, a region to which the player mainly pays attention is the battle region 1. After the virtual character a in the battle region 1 wins, the virtual character a moves to the battle region 2.

For example, FIG. 12 is a schematic diagram of an animation in which a character arrives at another battle region. As shown in FIG. 12, in a battle image 1200, after the virtual character a arrives at the close battle region 2, a zoom in is performed with the virtual camera, so that the battle region 1 is moved out of the image (that is, is not displayed), and the battle region 2 is the region closest to the virtual camera.

In some aspects, if the virtual character a moves to the battle region 3 after the virtual character a in the battle region 1 wins, a zoom in may be performed with the virtual camera, so that the battle region 1 is moved out of the image, and the battle region 2 is the region closest to the virtual camera.

In some other aspects, the first camera movement animation of the battle image is displayed in a process of displaying the battle switching animation.

For example, as shown in FIG. 11, a battle region currently closest to the virtual camera is the battle region 1. After the virtual character a in the battle region 1 wins, the virtual character a moves to the battle region 2, and a zoom in is synchronously performed with the virtual camera in a process in which the virtual character a moves to the battle region 2.

As shown in FIG. 12, when the virtual character a arrives at the close battle region 2, the zoom in with the virtual camera ends. In this case, the battle region 1 is moved out of the image, and the battle region 2 is the region closest to the virtual camera.

In some aspects, the battle switching animation may be implemented as the jumping animation. In this case, the jumping animation is displayed if the first virtual character in the i^{th} battle region satisfies the first battle ending condition, the jumping animation being the animation in which the first virtual character in the i^{th} battle region jumps to the j^{th} battle region.

In some aspects, when the distance between the j^{th} battle region and the virtual camera is reduced, a special effect intensity corresponding to the j^{th} battle region is increased to a target special effect intensity, and a battle animation corresponding to the j^{th} battle region is displayed with the target special effect intensity.

For example, when the zoom in is performed with the virtual camera, a distance between each battle region and the virtual camera changes. Therefore, a special effect intensity corresponding to each battle region needs to be re-determined. In some aspects, if battle regions 1 to 4 are included, distances between the battle regions 1 to 4 and the virtual camera are: the battle region 1<the battle region 2<the battle region 3<the battle region 4. Special effect intensities of battle special effects in battle animations are determined based depth ranges corresponding to the battle regions, so that the battle animations corresponding to the battle regions are displayed with different special effect intensities. On the one hand, a clear distinction is drawn between the primary and the secondary in the battle regions in the battle image by differentiating the special effect intensities. On the other hand, the battle animations are displayed with different special effect intensities, so that performance pressure of a computer is reduced.

In this case, the special effect intensities corresponding to the battle regions 1 to 4 are: the battle region 1>the battle region 2>the battle region 3>the battle region 4. When the zoom in is performed on the battle region 2 with the virtual camera, the battle region 1 is moved out of the image, and the distances between the battle regions 2 to 4 and the virtual camera are: the battle region 2<the battle region 3<the battle region 4. In this case, the special effect intensities corresponding to the battle regions 2 to 4 are: the battle region 2>the battle region 3>the battle region 4.

Alternatively, the special effect intensities corresponding to the battle regions 1 to 4 are: the battle region 1>the battle region 2=the battle region 3=the battle region 4. When the zoom in is performed on the battle region 2 with the virtual camera, the battle region 1 is moved out of the image, and the distances between the battle regions 2 to 4 and the virtual camera are: the battle region 2<the battle region 3<the battle region 4. In this case, the special effect intensities corresponding to the battle regions 2 to 4 are: the battle region 2>the battle region 3=the battle region 4.

In some other aspects, the j^{th} battle region may alternatively be a region selected by the player. For example, a selection operation on the j^{th} battle region in the another battle region other than the i^{th} battle region is received when the first virtual character in the i^{th} battle region satisfies the first battle ending condition, and the battle switching animation is displayed in response to the selection operation.

When the first virtual character in the i^{th} battle region satisfies the first battle ending condition, and the i^{th} battle region is not the region closest to the virtual camera, only the battle switching animation is displayed, and the first camera movement animation of the battle image is not displayed.

For example, refer to FIG. 12. After the virtual character c in the battle region 3 wins, the virtual character c moves to the battle region 2, and no zoom in is performed with the virtual camera in a process in which the virtual character c moves to the battle region 2 or after the virtual character c moves to the battle region 2.

In some other aspects, when the first virtual character in the i^{th} battle region satisfies a second battle ending condition, and the i^{th} battle region is a region in the n battle regions that is closest to the virtual camera, a second camera movement animation of the battle image is displayed.

The second camera movement animation is configured for moving the i^{th} battle region out of a battle image displayed by a current terminal. The second battle ending condition is configured for indicating that the first virtual character in the i^{th} battle region fails in battling.

In some aspects, the second camera movement animation is further configured for adjusting the j^{th} battle region to a region in the n battle regions that is closest to the virtual camera.

The j^{th} battle region is a battle region in a plurality of battle regions that is closest to the i^{th} battle region. Alternatively, the j^{th} battle region is a battle region in a plurality of battle regions that is closest to the i^{th} battle region and in which an attribute value of a second virtual character is greater than a preset attribute value.

For example, after a first virtual character in the battle region 1 closest to the camera is eliminated, a zoom in is performed with the camera on a battle region closest to the battle region 1. Alternatively, a zoom in is performed with the camera on a battle region that is closest to the battle region 1 and in which a second virtual character is not eliminated.

In some aspects, when the first virtual character in the i^{th} battle region satisfies a second battle ending condition, and the i^{th} battle region is not a region in the n battle regions that is closest to the virtual camera, a second camera movement animation of the battle image is not displayed.

In summary, according to the virtual battle display method provided in this aspect described herein, after the virtual battle between the plurality of first virtual characters and the plurality of second virtual characters is started, the battle image of the virtual battle displays a plurality of battle regions obtained through division based on the depth of field range of the image, and the plurality of first virtual characters and the plurality of second virtual characters are dispersedly displayed in the battle regions, so that a battle animation between a first virtual character and a second virtual character included in each battle region is displayed in the battle region. On the one hand, the plurality of first virtual characters and the plurality of second virtual characters may be dispersed in separate battle regions for battling, and a player can obtain a battle status of each virtual character from each battle region, to perform targeted adjustment, so that the efficiency of the player in controlling the virtual battle is improved. On the other hand, the battle image is divided into the battle regions based on the depth of field range of the image, and the battle image may be differently displayed, so that the player can focus on one or several battle images, avoiding scattering of a focus of the player caused by indiscriminate display of the plurality of battle regions, and further improving the efficiency of the player in controlling the virtual battle.

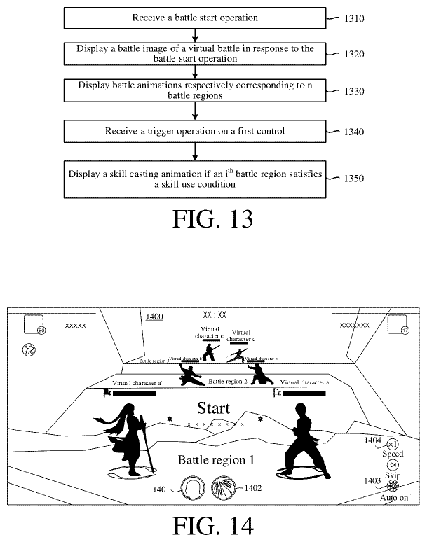

In some illustrative aspects, the battle image includes a control that may trigger a shared skill, and the shared skill is a skill that can be used by all of the plurality of first virtual characters. For example, as shown in FIG. 13, the aspect shown in FIG. 3 may alternatively be implemented as the following operation 1310 to operation 1350.

Operation 1310: Receive a battle start operation.

The battle start operation is configured for starting a virtual battle. The virtual battle is a battle between a plurality of first virtual characters and a plurality of second virtual characters.

In some aspects, a battle preparation interface is displayed, the battle preparation interface including a battle start control. A trigger operation on the battle start control is received, and the trigger operation is used as the battle start operation.

For example, the battle preparation interface includes a character selection region. The character selection region is a region in which the plurality of first virtual characters are selected as a whole. If a lineup 1 (having a strong defensive ability) and a lineup 2 (having a high attacking force) are included, a player may select, based on a lineup of an opponent, a lineup beneficial to a victory for battling.

An optional lineup included in the character selection region may be a lineup preconfigured by the player, or may be a recommended lineup configured by a system based on the lineup of the opponent.

In some aspects, the battle preparation interface is an interface displayed when a current moment reaches a reserved moment.

For example, the player may reserve the virtual battle in an application. If reserved time is 10:30, the application pushes a card message at 10:25 (which is merely an example, or may be another time point in advance). When the player taps the card message, the battle preparation interface is displayed. In this case, if the player taps the battle start control in the battle preparation interface, the virtual battle is immediately started. Alternatively, the battle preparation interface includes a battle start countdown, and when the countdown ends, that is, the current moment is 10:30, the virtual battle is started.

Operation 1320: Display a battle image of the virtual battle in response to the battle start operation.

In some aspects, a depth of field range corresponding to the battle image is a depth range from a foreground to a background of the battle image. In some aspects, the battle image is an image that is acquired via a virtual camera and that has the depth of field range. A depth within a depth range corresponding to a battle region in an image closer to the virtual camera is smaller, and a depth within a depth range corresponding to a battle region in an image farther away from the virtual camera is larger. In other words, division into battle regions based on the depth of field range corresponding to the battle image is division into the battle regions based on distances to the virtual camera.

In some aspects, a first control configured to trigger a first skill is displayed, and the first skill is a shared skill corresponding to the plurality of first virtual characters.

In other words, any virtual character in the plurality of first virtual characters may use the skill.

In some aspects, the first skill includes at least one of a summon skill, a defense skill, a prop skill, a heal skill, and the like. A type of the first skill is not limited in this aspect described herein.

For example, the summon skill may summon one or more additional virtual characters, to assist a virtual character currently using the skill in battling. The defense skill may increase a defense value corresponding to a virtual character currently using the skill. The prop skill may summon a prop (for example, a virtual grenade) to assist a virtual character currently using the skill in battling. The heal skill may increase a hit point corresponding to a virtual character currently using the skill.

In some aspects, there may be one or more first controls. To be specific, if one or more controls may be displayed in the battle image, the plurality of first virtual characters may correspond to one or more shared skills.

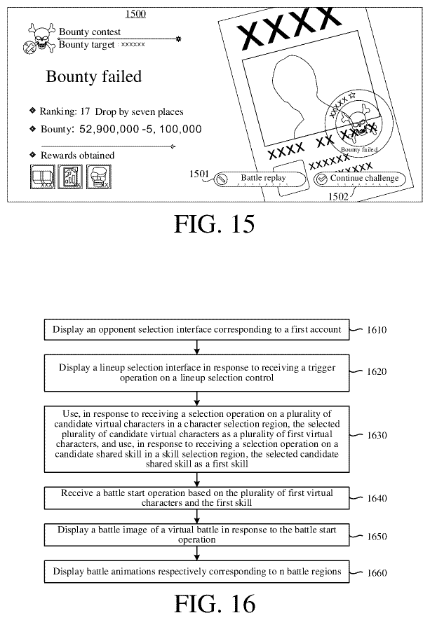

For example, FIG. 14 is a schematic diagram of a battle image. A battle image 1400 includes a control 1401 and a control 1402. The control 1401 and the control 1402 are both controls that can trigger the shared skill.

For example, the control 1401 may summon a virtual character d to assist a virtual character using the skill in battling. The control 1402 is a fireball skill, and after the control 1402 is triggered, a virtual character using the skill casts a fireball to attack an enemy character.

Operation 1330: Display battle animations respectively corresponding to n battle regions.

A battle animation corresponding to an i^{th} battle region is an animation of battling between a first virtual character in the i^{th} battle region and a second virtual character in the i^{th} battle region.

For example, as shown in FIG. 14, after the virtual battle is triggered to be started, a virtual character a, a virtual character b, and a virtual character c, as well as opponents, that is, a virtual character a′, a virtual character b′, and a virtual character c′ are divided into three combinations, to perform one-on-one battles in corresponding battle regions. Three battle regions in FIG. 14 are separated regions, so that the battles performed in the three battle regions are independent and do not interfere with each other.

Operation 1340: Receive a trigger operation on the first control.

In some aspects, the trigger operation includes at least one of a single-tap operation, a double-tap operation, a long-press operation, a slide operation, a voice instruction operation, a gesture instruction operation, and the like.

Operation 1350: Display a skill casting animation if the i^{th} battle region satisfies a skill use condition.

The skill casting animation is an animation in which the first virtual character in the i^{th} battle region casts the first skill. In some aspects, the skill use condition includes at least one of the following conditions.

1: Display the skill casting animation if a depth range corresponding to the i^{th} battle region is less than a depth range corresponding to another battle region in the n battle regions.

To be specific, if the i^{th} battle region is a battle region in the n battle regions that is closest to a virtual camera, it is determined that the i^{th} battle region satisfies the skill use condition, and the skill casting animation is displayed.

For example, refer to FIG. 14. The player taps the control 1401. In this case, the virtual character a in a battle region 1 closest to the virtual camera summons the virtual character d. The virtual character d may assist the virtual character a in attacking the virtual character a′. Alternatively, the player taps the control 1402. In this case, the virtual character a in a battle region 1 closest to the virtual camera throws a fireball at the virtual character a′.

2: Display the skill casting animation if an attribute value of the first virtual object in the i^{th} battle region satisfies a first attribute value requirement.

For example, if the attribute value of the first virtual object in the i^{th} battle region at a moment when the player triggers the first control is a virtual character in the n battle regions whose attribute value is minimum and is not 0, the first virtual character in the i^{th} battle region is controlled to use the first skill.

In some other aspects, the player may select a virtual character that needs to use a skill. In some aspects, a long-press operation on the first control is received. A slide operation following the long-press operation is received, a location of a slide starting point of the slide operation being the same as a pressing location of the long-press operation. The skill casting animation is displayed in response to a slide end point indicated by the slide operation being in the i^{th} battle region.

For example, the player may determine, through the slide operation following the long-press operation on the first control, a first virtual character needing to use a skill. When the player slides the first control to the i^{th} battle region and stops the slide operation, the first virtual character in the i^{h} battle region is used as a virtual character using the first skill.

In some other aspects, the first skill is a skill with which the system automatically selects a virtual character and automatically selects a trigger timing.

In some aspects, the battle image includes a fourth control, and the fourth control is configured for enabling a function of the system for automatically triggering the first skill. An enable operation on the fourth control is received. When a target virtual character in the plurality of first virtual characters conforms to a skill trigger condition, the skill casting animation is displayed. The skill casting animation is an animation in which the target virtual character casts the first skill.

For example, as shown in FIG. 14, the battle image 1400 includes an “Auto on” button 1403 (that is, the fourth control). After the “Auto on” button 1403 is triggered, artificial intelligence (AI) determines a character and timing for casting the shared skill. For example, if the shared skill is a medkit skill, when AI determines that a hit point of the virtual character b in the battle region is less than or equal to a preset hit point, AI controls the virtual character b to use a medikit to heal the hit point.

In some aspects, an enable operation on the fourth control is received. If a depth range corresponding to the i^{th} battle region is less than a depth range corresponding to another battle region in the n battle regions, and the first virtual character in the i^{th} battle region satisfies a skill trigger condition, the skill casting animation is displayed. The skill casting animation is an animation in which the first virtual character in the i^{th} battle region casts the first skill.

For example, as shown in FIG. 14, after the “Auto on” button 1403 is triggered, artificial intelligence (AI) determines timing for casting the shared skill. A character using the shared skill is constantly a first virtual character in a battle region closest to the virtual camera. For example, if the shared skill is the summon skill, when AI determines that a combo of the virtual character a in the battle region 1 is interrupted by the virtual character a′, AI controls the virtual character a to summon the virtual object b to assist the virtual character a in battling.

In some aspects, the battle image of the virtual battle further includes an animation speed control, and the animation speed control is configured to adjust a playback speed of an animation displayed in the battle image.

In response to receiving a trigger operation on the animation speed control, it is determined that playback speeds of the battle animations respectively corresponding to the n battle regions are a first playback speed. The battle animations respectively corresponding to the n battle regions are displayed based on the first playback speed.

For example, refer to FIG. 14. The battle image 1400 includes a “Speed” button 1404, and the “Speed” button 1404 may be tapped to switch a playback speed of an animation played in the current battle image 1400. For example, “×1” indicates playback at an original playback speed, and “×2” indicates playback at twice the original playback speed.

The playback speed of the animation in the battle image may be controlled by using the animation speed control, so that playback efficiency of the battle animation is improved, and a rate of control of the player over the battle image is increased.

In some aspects, the virtual battle corresponds to a battle ending condition.

In some aspects, the battle ending condition includes at least one of the following cases: ending the virtual battle when start duration of the virtual battle reaches preset duration; ending the virtual battle when a quantity of remaining first virtual characters that are not eliminated is less than or equal to a first quantity threshold; and ending the virtual battle when a quantity of remaining second virtual characters that are not eliminated is less than or equal to a second quantity threshold.

For example, if all of the plurality of second virtual characters are eliminated, the virtual battle is ended, and it is determined that a party corresponding to the plurality of first virtual characters wins; or when the start duration of the virtual battle reaches 10 minutes, the virtual battle is ended, and if the quantity of remaining first virtual characters on a field that are not eliminated is greater than the quantity of second virtual characters that are not eliminated, it is determined that a party corresponding to the plurality of first virtual characters wins.

For example, if all of the plurality of first virtual characters are eliminated, the virtual battle is ended, and it is determined that a party corresponding to the plurality of first virtual characters fails; or when the start duration of the virtual battle reaches 10 minutes, the virtual battle is ended, and if the quantity of remaining first virtual characters on a field that are not eliminated is less than the quantity of second virtual characters that are not eliminated, it is determined that a party corresponding to the plurality of first virtual characters fails.

Refer to FIG. 15. If all of the plurality of first virtual characters are eliminated, the player fails to challenge, and a battle ending interface 1500 is displayed. The battle ending interface 1500 includes a “Battle replay” button 1501 and a “Continue challenge” button 1502. When the “Battle replay” button 1501 is triggered, a recorded image of an ended virtual battle may be watched. When the “Continue challenge” button 1502 is triggered, a virtual battle can be restarted.

In summary, according to the virtual battle display method provided in this aspect described herein, after the virtual battle between the plurality of first virtual characters and the plurality of second virtual characters is started, the battle image of the virtual battle displays a plurality of battle regions obtained through division based on the depth of field range of the image, and the plurality of first virtual characters and the plurality of second virtual characters are dispersedly displayed in the battle regions, so that a battle animation between a first virtual character and a second virtual character included in each battle region is displayed in the battle region. On the one hand, the plurality of first virtual characters and the plurality of second virtual characters may be dispersed in separate battle regions for battling, and a player can obtain a battle status of each virtual character from each battle region, to perform targeted adjustment, so that the efficiency of the player in controlling the virtual battle is improved. On the other hand, the battle image is divided into the battle regions based on the depth of field range of the image, and the battle image may be differently displayed, so that the player can focus on one or several battle images, avoiding scattering of a focus of the player caused by indiscriminate display of the plurality of battle regions, and further improving the efficiency of the player in controlling the virtual battle.

According to the method provided in this aspect described herein, the battle image includes the first control configured to trigger the shared skill. After the first control is triggered, if the i^{th} battle region satisfies the skill use condition, the animation in which the first virtual character in the i^{th} battle region casts the shared skill is displayed. The player triggers the first control at appropriate time, so that an ally character closest to the camera may cast an additional skill to attack an enemy character. The first control has a particular function of turning the tide of the battle, accelerating a battle progress and improving battle efficiency of the virtual battle.

In some aspects, before the virtual battle is started, the plurality of first virtual characters corresponding to the currently started virtual battle need to be determined. For example, as shown in FIG. 16, the aspect shown in FIG. 3 may alternatively be implemented as the following operation 1610 to operation 1660.

Operation 1610: Display an opponent selection interface corresponding to a first account.

In some aspects, the first account is an account logging in to a turn-based action game on a current terminal, and the opponent selection interface includes a plurality of candidate opponents. The candidate opponents include a plurality of second virtual characters preset by another account, and/or a plurality of second virtual characters set by a system.

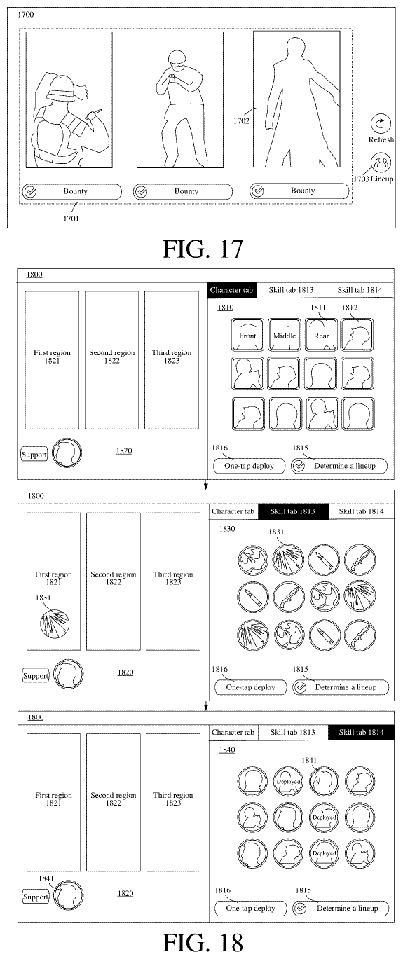

For example, FIG. 17 is a schematic diagram of an opponent selection interface. An opponent selection interface 1700 includes an opponent selection region 1701. The opponent selection region 1701 includes a plurality of different candidate opponents. A candidate opponent 1702 may be tapped to jump to an opponent details interface (refer to FIG. 7), to view lineup details of the candidate opponent 1702. A player may determine an opponent from the plurality of candidate opponents by viewing lineup details of the candidate opponents.

The opponent selection interface includes a lineup selection control, and the lineup selection control is configured to determine a plurality of first virtual characters corresponding to the first account, that is, a lineup corresponding to the first account.

For example, the opponent selection interface 1700 in FIG. 17 further includes a lineup selection control 1703 that may be triggered to determine the battle lineup corresponding to the first account.

Operation 1620: Display a lineup selection interface in response to receiving a trigger operation on the lineup selection control.

The lineup selection interface includes a character selection region, and the character selection region includes a plurality of candidate virtual characters.

In some aspects, the lineup selection interface further includes a skill selection region, and the skill selection region includes a plurality of candidate shared skills.

In some aspects, the lineup selection interface further includes a lineup display region, and the lineup display region is configured for displaying a selected candidate virtual character and a selected candidate shared skill.

For example, FIG. 18 is a schematic diagram of a lineup selection interface. After the lineup selection control 1703 in FIG. 17 is triggered, a lineup selection interface 1800 shown in FIG. 18 is displayed. The lineup selection interface 1800 includes a character selection region 1810, and the character selection region 1810 includes a plurality of candidate virtual characters.

In some aspects, after the lineup selection interface 1800 is triggered, a candidate virtual character ranked top in the character selection region 1810 is a selected candidate virtual character by default, and the candidate virtual character is sequentially displayed in a first region 1821, a second region 1822, and a third region 1823 in the lineup display region 1820. An arrangement sequence identifier is displayed on the selected candidate virtual character. The arrangement sequence identifier is configured for indicating a battle region in which the candidate virtual character is located.

In FIG. 18, a candidate virtual character on which a “Front” identifier is displayed is displayed in the first region 1821. A candidate virtual character that participates in the virtual battle in the battle region 1 shown in FIG. 14 and on which a “Middle” identifier is displayed is displayed in the second region 1822. A candidate virtual character that participates in the virtual battle in the battle region 2 shown in FIG. 14 and on which a “Rear” identifier is displayed is displayed in the third region 1823, and is to participate in the virtual battle in the battle region 3 shown in FIG. 14.

If the player needs to modify a candidate virtual character for battling, for example, modify a candidate virtual character 1811 on which the “Rear” identifier is displayed, the player may tap the candidate virtual character 1811 again to cancel the corresponding “Rear” identifier, and the candidate virtual character 1811 is undisplayed in the third region 1823. Subsequently, if a candidate virtual character 1812 is selected, the “Rear” identifier is displayed on the candidate virtual character 1812, and the character displayed in the third region 1823 in the lineup display region 1820 is modified to the candidate virtual character 1812, that is, the candidate virtual character 1811 that participates in the battle in the battle region 3 is modified to the candidate virtual character 1812.

In some aspects, a shared skill (that is, the foregoing first skill) may be further determined in the lineup selection interface 1800. It is assumed that the current first account may select a first shared skill and a second shared skill, where the first shared skill is configured for casting a virtual prop or a virtual skill to assist a virtual character currently using the skill in battling, and the second shared skill is configured for summoning an additional virtual character to assist a virtual character currently using the skill in battling.

For example, a skill tab 1813 in the lineup selection interface 1800 is tapped, and a first shared skill selection region 1830 is displayed. The first shared skill selection region 1830 includes a plurality of candidate skills. A candidate skill 1831 is tapped, and the candidate skill 1831 is displayed in the first region 1821.

A skill tab 1814 in the lineup selection interface 1800 is tapped, and a second shared skill selection region 1840 is displayed. The second shared skill selection region 1840 includes a plurality of candidate virtual characters that may be additionally summoned. In some aspects, the plurality of candidate virtual characters are the same as the plurality of candidate virtual characters in the character selection region 1810, or the plurality of candidate virtual characters are different from the plurality of candidate virtual characters in the character selection region 1810.

When the plurality of candidate virtual characters are the same as the plurality of candidate virtual characters in the character selection region 1810, if it is determined that a target candidate virtual character in the second shared skill selection region 1840 is a candidate virtual character selected in the character selection region 1810, the candidate virtual character cannot be selected as an additionally summoned virtual character. In some aspects, a candidate virtual character 1841 is tapped, and the candidate virtual character 1841 is displayed in the lineup display region 1820 as a candidate skill.

Operation 1630: Use, in response to receiving a selection operation on a plurality of candidate virtual characters in the character selection region, the selected plurality of candidate virtual characters as the plurality of first virtual characters, and use, in response to receiving a selection operation on a candidate shared skill in the skill selection region, the selected candidate shared skill as a first skill.

The first skill is a shared skill corresponding to the plurality of first virtual characters.

In some aspects, after the plurality of candidate virtual characters and the candidate shared skill are selected, the selected candidate shared skill is used as the first skill in response to receiving a determining operation for selecting the plurality of candidate virtual characters and the candidate shared skill in the lineup selection interface. The first skill is the shared skill corresponding to the plurality of first virtual characters.

For example, refer to FIG. 18. The lineup selection interface 1800 includes a “Determine a lineup” button 1815. After a plurality of candidate virtual characters and two candidate skills are selected, the “Determine a lineup” button 1815 may be tapped, to determine the plurality of candidate virtual characters as the plurality of first virtual characters for battling and use the two candidate skills as shared skills (that is, first skills).

In some aspects, the lineup selection interface includes an automatic lineup determining control. After triggered, the automatic lineup determining control is used by the system to determine the plurality of first virtual characters and the shared skill corresponding to the first account.

In some aspects, the system determines the plurality of first virtual characters based on character parameters of the plurality of candidate virtual characters. The character parameter includes a type of the candidate virtual character, a preset attribute value, a preset skill, and the like. This is not limited in this aspect described herein.

In some aspects, the lineup selection interface 1800 includes a “One-tap deploy” button 1816. After the “One-tap deploy” button 1816 is triggered, the system automatically determines the plurality of first virtual characters from the plurality of candidate virtual characters, and automatically determines the shared skill.

Operation 1640: Receive a battle start operation based on the plurality of first virtual characters and the first skill.

For example, after the “Determine a lineup” button 1815 or the “One-tap deploy” button 1816 is triggered, the opponent selection interface 1700 shown in FIG. 17 is displayed. Each candidate opponent in the opponent selection interface 1700 corresponds to a “Bounty” button. A “Bounty” button corresponding to a selected opponent is tapped to enter a virtual battle with the opponent.

Alternatively, a candidate opponent is tapped to enter the opponent details interface 700 shown in FIG. 7. The opponent details interface 700 includes a “Bounty” button 704 corresponding to the opponent. The “Bounty” button 704 corresponding to the selected opponent is tapped to enter a virtual battle with the opponent.

Operation 1650: Display a battle image of the virtual battle in response to the battle start operation.

The battle image includes n battle regions. The n battle regions are regions obtained through division based on a depth of field range corresponding to the battle image. An i^{th} battle region includes at least one first virtual character in the plurality of first virtual characters and at least one second virtual character in the plurality of second virtual characters, n is an integer greater than 1, and 0<i≤n.

In some aspects, the battle image includes a first battle region, a second battle region, and a third battle region, and the first battle region, the second battle region, and the third battle region are regions obtained through division based on the depth of field range corresponding to the battle image. The first battle region includes at least one first virtual character in the plurality of first virtual characters and at least one second virtual character in the plurality of second virtual characters.

In some aspects, if a quantity of the plurality of first virtual characters is three, the first battle region includes one first virtual character in the plurality of first virtual characters and one second virtual character in the plurality of second virtual characters. Each battle region includes a different first virtual character and a different second virtual character.

For example, refer to FIG. 14. After the virtual battle is entered, a battle image 1400 of the virtual battle is displayed, a virtual character a, a virtual character b, and a virtual character c in the battle image 1400 correspond to candidate virtual characters selected in the character selection region, and a control 1401 and a control 1402 in the battle image 1400 correspond to candidate shared skills selected in the character selection region.

Operation 1660: Display battle animations respectively corresponding to the n battle regions.

A battle animation corresponding to an i^{th} battle region is an animation of battling between a first virtual character in the i^{th} battle region and a second virtual character in the i^{th} battle region.

The battle image of the virtual battle and the battle animations have been described in operation 1320 to operation 1350, and details are not described herein again.

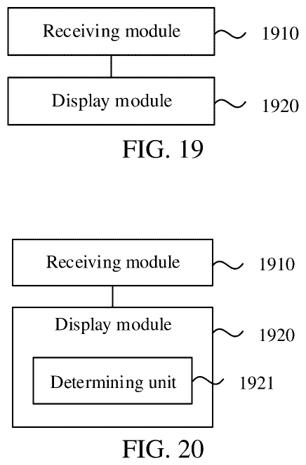

FIG. 19 is a block diagram of a structure of a virtual battle display apparatus according to an illustrative aspect described herein. As shown in FIG. 19, the apparatus includes the following parts:
a receiving module 1910, configured to receive a battle start operation, the battle start operation being configured for starting a virtual battle, and the virtual battle being a battle between a plurality of first virtual characters and a plurality of second virtual characters; and
a display module 1920, configured to display a battle image of the virtual battle in response to the battle start operation, the battle image including n battle regions, the n battle regions being regions obtained through division based on a depth of field range of the battle image, an i^{th} battle region including at least one first virtual character and at least one second virtual character, n being an integer greater than 1, and 0<i≤n.

The display module 1920 is further configured to display battle animations respectively corresponding to the n battle regions, a battle animation corresponding to the i^{th} battle region including an animation of battling between the first virtual character in the i^{th} battle region and the second virtual character in the i^{th} battle region.

In some aspects, refer to FIG. 20. The display module 1920 is further configured to display a battle switching animation if the first virtual character in the i^{th} battle region satisfies a first battle ending condition, the first battle ending condition being configured for indicating that the first virtual character in the i^{th} battle region is successful in battling, the battle switching animation including an animation of switching the first virtual character in the i^{th} battle region to a j^{th} battle region for battling, 0<j≤n, and i≠j.

In some aspects, the display module 1920 includes:
a determining unit 1921, configured to: determine a distance between the i^{th} battle region and another battle region in the n battle regions, and determine, from the another battle region, the j^{th} battle region whose distance to the i^{th} battle region meets a distance requirement.

The display module 1920 is further configured to display the battle switching animation.

In some aspects, the determining unit 1921 is configured to: determine an attribute value of a first virtual character in the another battle region other than the i^{th} battle region, and determine, from the another battle region, the j^{th} battle region in which an attribute value of a first virtual character meets an attribute value requirement. The display module 1920 is further configured to display the battle switching animation.

In some aspects, the battle image is an image that is acquired via a virtual camera and that has the depth of field range. The display module 1920 is further configured to display a first camera movement animation of the battle image if the first virtual character in the i^{th} battle region satisfies the first battle ending condition, the first camera movement animation being configured for adjusting a distance between the j^{th} battle region and the virtual camera.

In some aspects, the i^{th} battle region is a region in the n battle regions that is closest to the virtual camera. The first camera movement animation is configured for moving the i^{th} battle region out of a battle image displayed by a current terminal, and adjusting the j^{th} battle region to a region in the n battle regions that is closest to the virtual camera.

In some aspects, the display module 1920 is further configured to display a second camera movement animation of the battle image if the first virtual character in the i^{th} battle region satisfies a second battle ending condition and the i^{th} battle region is a region in the n battle regions that is closest to the virtual camera, the second battle ending condition being configured for indicating that the first virtual character in the i^{th} battle region fails in battling, and the second camera movement animation being configured for moving the i^{th} battle region out of a battle image displayed by a current terminal.

In some aspects, the display module 1920 is further configured to determine, based on a depth range corresponding to the i^{th} battle region, a special effect intensity of a battle special effect in the battle animation corresponding to the i^{th} battle region. The display module 1920 is further configured to display the battle animation corresponding to the i^{th} battle region based on the special effect intensity.

In some aspects, an interface includes a first control configured to trigger a first skill, and the first skill is a shared skill corresponding to the plurality of first virtual characters. The receiving module 1910 is configured to receive a trigger operation on the first control. The display module 1920 is further configured to display a skill casting animation if the i^{th} battle region satisfies a skill use condition, the skill casting animation being an animation in which the first virtual character in the i^{th} battle region casts the first skill.

In some aspects, the display module 1920 is further configured to display the skill casting animation if the depth range corresponding to the i^{th} battle region is less than a depth range corresponding to the another battle region in the n battle regions.

In some aspects, the display module 1920 is further configured to:
display, in response to the battle start operation, a battle background image corresponding to the virtual battle, the battle background image including the n battle regions;
display a character creation animation, the character creation animation being an animation of creating the plurality of first virtual characters and the plurality of second virtual characters in the n battle regions; and
display the battle image after playback of the character creation animation ends.

In some aspects, the display module 1920 is further configured to:
display simultaneously the battle animations respectively corresponding to the n battle regions; or
display, sequentially based on a region sequence corresponding to the n battle regions, the battle animations respectively corresponding to the n battle regions.

In some aspects, the battle image includes a second control for triggering the battle animation. The display module 1920 is further configured to display, in response to receiving a trigger operation on the second control, the battle animations respectively corresponding to the n battle regions.

In some aspects, the receiving module 1910 is configured to receive a long-press operation on the second control. The receiving module 1910 is configured to receive a slide operation following the long-press operation, a location of a slide starting point of the slide operation being the same as a pressing location of the long-press operation. The display module 1920 is further configured to display, in response to a slide end point indicated by the slide operation being in the i^{th} battle region, the battle animation corresponding to the i^{th} battle region. The display module 1920 is further configured to display, after the battle animation corresponding to the i^{th} battle region starts to be played, a battle animation corresponding to another battle region in the n battle regions.

In some aspects, the battle image includes an animation speed control, and the animation speed control is configured to adjust a playback speed of an animation displayed in the battle image. The determining unit 1921 is configured to determine, in response to receiving a trigger operation on the animation speed control, that playback speeds of the battle animations respectively corresponding to the n battle regions are a first playback speed. The display module 1920 is further configured to display, based on the first playback speed, the battle animations respectively corresponding to the n battle regions.

In some aspects, the display module 1920 is further configured to display a lineup selection interface, the lineup selection interface including a character selection region, and the character selection region including a plurality of candidate virtual characters. The receiving module 1910 is configured to use, in response to receiving a selection operation on a plurality of candidate virtual characters in the character selection region, the selected plurality of candidate virtual characters as the plurality of first virtual characters.

In some aspects, the lineup selection interface includes a skill selection region, and the skill selection region includes a plurality of candidate shared skills. The receiving module 1910 is configured to use, in response to receiving a selection operation on a candidate shared skill in the skill selection region, the selected candidate shared skill as the first skill, the first skill being the shared skill corresponding to the plurality of first virtual characters.

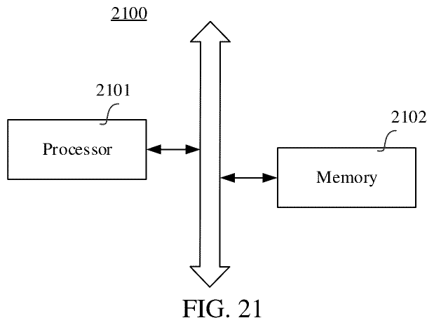

FIG. 21 is a block diagram of a structure of an electronic device 2100 according to an illustrative aspect described herein. The electronic device 2100 may be a portable mobile terminal, for example, a smartphone, an in-vehicle terminal, a tablet computer, a moving picture experts group audio layer III (MP3) player, a moving picture experts group audio layer IV (MP4) player, a notebook computer, or a desktop computer. The electronic device 2100 may also be referred to by another name such as user equipment, a portable terminal, a laptop terminal, or a desktop terminal.

Generally, the electronic device 2100 includes a processor 2101 and a memory 2102.

The processor 2101 may include one or more processing cores, for example, a four-core processor or an eight-core processor. The processor 2101 may be implemented in at least one hardware form of a digital signal processor (DSP), a field programmable gate array (FPGA), and a programmable logic array (PLA). Alternatively, the processor 2101 may include a main processor and a co-processor. The main processor is a processor configured to process data in an awake state, and is also referred to as a central processing unit (CPU). The co-processor is a low power consumption processor configured to process the data in a standby state. In some aspects, the processor 2101 may be integrated with a graphics processing unit (GPU), and the GPU is configured to render and draw content that needs to be displayed on a display screen. In some aspects, the processor 2101 may alternatively include an AI processor, and the AI processor is configured to process a computing operation related to machine learning.

The memory 2102 may include one or more computer-readable storage media. The computer-readable storage medium may be non-transitory. The memory 2102 may further include a high-speed random access memory and a non-volatile memory, for example, one or more disk storage devices or flash storage devices. In some aspects, the non-transitory computer-readable storage medium in the memory 2102 is configured to store at least one instruction, and the at least one instruction is configured for being executed by the processor 2101 to implement the virtual battle display method provided in the method aspects described herein.

In some aspects, the electronic device 2100 further includes one or more sensors. The one or more sensors include but are not limited to a proximity sensor, a gyroscope sensor, and a pressure sensor.

The proximity sensor, also referred to as a distance sensor, is usually arranged on a front panel of the electronic device 2100. The proximity sensor is configured to acquire a distance between a user and a front surface of the electronic device 2100.

The gyroscope sensor may detect a body direction and a rotation angle of the electronic device 2100. The gyroscope sensor may cooperate with an acceleration sensor to acquire a 3D action of the user on the electronic device 2100. The processor 2101 may implement the following functions based on the data acquired by the gyroscope sensor: motion sensing (such as changing a UI based on a tilt operation of the user), image stabilization at shooting, game control, and inertial navigation.

The pressure sensor may be arranged on a side frame of the electronic device 2100 and/or a lower layer of the display screen. When the pressure sensor is arranged on the side frame of the electronic device 2100, a holding signal of the user on the electronic device 2100 may be detected, and the processor 2101 may perform left/right hand identification or a quick operation based on the holding signal acquired by the pressure sensor. When the pressure sensor is arranged on the lower layer of the display screen, the processor 2101 controls, based on a pressure operation of the user on the display screen, an operable control on the UI. The operable control includes at least one of a button control, a scroll-bar control, an icon control, and a menu control.

In some aspects, the electronic device 2100 further includes another component part. A person skilled in the art may understand that the structure shown in FIG. 21 constitutes no limitation on the electronic device 2100, and the electronic device may include more or fewer components than those shown in the figure, or some components may be combined, or a different component deployment may be used.

An aspect described herein further provides a computer device. The computer device may be implemented as the terminal or the server shown in FIG. 2. The computer device includes a processor and a memory. The memory has at least one instruction, at least one program, a code set, or an instruction set stored therein. The at least one instruction, the at least one program, the code set, or the instruction set is loaded and executed by the processor to implement the virtual battle display method provided in each of the foregoing method aspects.

An aspect described herein further provides a computer-readable storage medium. The computer-readable storage medium has at least one instruction, at least one program, a code set, or an instruction set stored therein. The at least one instruction, the at least one program, the code set, or the instruction set is loaded and executed by a processor to implement the virtual battle display method provided in each of the foregoing method aspects.

An aspect described herein further provides a computer program product or computer program. The computer program product or computer program includes computer instructions. The computer instructions are stored in a computer-readable storage medium. A processor of a computer device reads the computer instructions from the computer-readable storage medium. The processor executes the computer instructions, so that the computer device performs the virtual battle display method according to any one of the foregoing aspects.

What is claimed is:

1. A computer-implemented method, comprising:
receiving a battle start operation, the battle start operation being configured for starting a virtual battle, and the virtual battle being a battle between a plurality of first virtual characters and a plurality of second virtual characters;
displaying a battle image of the virtual battle in response to the battle start operation, wherein the battle image comprises n battle regions, wherein n is determined using division based on a depth of field range of the battle image, and wherein each i^{th} battle region comprises at least one first virtual character and at least one second virtual character, where n is an integer greater than 1, and 0<i≤n; and
displaying a battle animation respectively corresponding to each of the n battle regions, wherein a battle animation corresponding to the i^{th} battle region comprises an animation of battling between the at least one first virtual character corresponding to the i^{th} battle region and the at least one second virtual character corresponding to the i^{th} battle region.

2. The method according to claim 1, wherein after the displaying the battle animations, the method further comprises:
displaying a battle switching animation when the at least one first virtual character corresponding to the i^{th} battle region satisfies a first battle ending condition, the first battle ending condition being configured for indicating that the at least one first virtual character corresponding to the i^{th} battle region is successful in battling the at least one second virtual character corresponding to the i^{th} battle region, the battle switching animation comprising an animation of switching the at least one first virtual character corresponding to the i^{th} battle region to a j^{th} battle region for battling, where 0<j≤n, and i≠j.

3. The method according to claim 2, wherein the displaying the battle switching animation comprises:
determining a distance between the i^{th} battle region and another battle region in the n battle regions;
determining, from the another battle region, the j^{th} battle region whose distance to the i^{th} battle region meets a distance requirement; and
displaying the battle switching animation.

4. The method according to claim 2, wherein the displaying the battle switching animation comprises:
determining an attribute value of a first virtual character in another battle region other than the i^{th} battle region;
determining, from the another battle region, the j^{th} battle region in which an attribute value of a first virtual character meets an attribute value requirement; and
displaying the battle switching animation.

5. The method according to claim 2, wherein the battle image is an image that is acquired via a virtual camera and that has the depth of field range; and
the method further comprises:
displaying a first camera movement animation of the battle image when the at least one first virtual character corresponding to the i^{th} battle region satisfies the first battle ending condition, the first camera movement animation being configured for adjusting a distance between the j^{th} battle region and the virtual camera.

6. The method according to claim 5, wherein the i^{th} battle region is a region in the n battle regions that is closest to the virtual camera, and the first camera movement animation is configured for moving the i^{th} battle region out of a battle image displayed by a current terminal, and adjusting the j^{th} battle region to a region in the n battle regions that is closest to the virtual camera.

7. The method of claim 1, wherein the displaying battle animations comprises:
determining, based on a depth range corresponding to the i^{th} battle region, a special effect intensity of a battle special effect in the battle animation corresponding to the i^{th} battle region; and
displaying, based on the special effect intensity, the battle animation corresponding to the i^{th} battle region.

8. The method of claim 1, wherein an interface comprises a first control configured to trigger a first skill, and the first skill is a shared skill corresponding to the plurality of first virtual characters; and
the method further comprises:
receiving a trigger operation on the first control; and
displaying a skill casting animation when the i^{th} battle region satisfies a skill use condition, the skill casting animation being an animation in which one of the at least one first virtual character in the i^{th} battle region casts the first skill.

9. The method according to claim 8, wherein the displaying the skill casting animation comprises:
displaying the skill casting animation when the depth range corresponding to the i^{th} battle region is less than a depth range corresponding to the another battle region in the n battle regions.

10. The method of claim 1, wherein the displaying the battle image comprises:
displaying, in response to the battle start operation, a battle background image corresponding to the virtual battle, the battle background image comprising the n battle regions;
displaying a character creation animation, the character creation animation being an animation of creating the plurality of first virtual characters and the plurality of second virtual characters in the n battle regions; and
displaying the battle image after playback of the character creation animation ends.

11. The method of claim 1, wherein the displaying battle animations comprises:
displaying simultaneously the battle animations respectively corresponding to the n battle regions; or
displaying, sequentially based on a region sequence corresponding to the n battle regions, the battle animations respectively corresponding to the n battle regions.

12. The of claim 1, wherein the battle image comprises a first control for triggering the battle animation; and
the displaying battle animations comprises:
displaying, in response to receiving a trigger operation on the first control, the battle animations respectively corresponding to the n battle regions.

13. The method according to claim 12, wherein the displaying, in response to receiving the trigger operation on the first control, the battle animations respectively corresponding to the n battle regions comprises:
receiving a long-press operation on the first control;
receiving a slide operation following the long-press operation, a location of a slide starting point of the slide operation being the same as a pressing location of the long-press operation;
displaying, in response to a slide end point indicated by the slide operation being in the i^{th} battle region, the battle animation corresponding to the i^{th} battle region; and
displaying, after the battle animation corresponding to the i^{th} battle region starts to be played, a battle animation corresponding to the another battle region in the n battle regions.

14. The method of claim 1, wherein the battle image comprises an animation speed control, and the animation speed control is configured to adjust a playback speed of an animation displayed in the battle image; and
the displaying battle animations respectively corresponding to the n battle regions comprises:
determining, in response to receiving a trigger operation on the animation speed control, that playback speeds of the battle animations respectively corresponding to the n battle regions are a first playback speed; and
displaying, based on the first playback speed, the battle animations respectively corresponding to the n battle regions.

15. The method of claim 1, wherein before the receiving a battle start operation, the method further comprises:
displaying a lineup selection interface, the lineup selection interface comprising a character selection region, and the character selection region comprising a plurality of candidate virtual characters; and
using, in response to receiving a selection operation on a plurality of candidate virtual characters in the character selection region, the selected plurality of candidate virtual characters as the plurality of first virtual characters.

16. The method according to claim 15, wherein the lineup selection interface comprises a skill selection region, and the skill selection region comprises a plurality of candidate shared skills; and
the method further comprises:
using, in response to receiving a selection operation on a candidate shared skill in the skill selection region, the selected candidate shared skill as the first skill, the first skill being the shared skill corresponding to the plurality of first virtual characters.

17. One or more non-transitory computer readable media comprising computer readable instructions that, when executed by a processor, configure a data processing system to perform:
receiving a battle start operation, the battle start operation being configured for starting a virtual battle, and the virtual battle being a battle between a plurality of first virtual characters and a plurality of second virtual characters;
displaying a battle image of the virtual battle in response to the battle start operation, wherein the battle image comprises n battle regions, wherein n is determined using division based on a depth of field range of the battle image, and wherein each i^{th} battle region comprises at least one first virtual character and at least one second virtual character, where n is an integer greater than 1, and 0<i≤n; and
displaying a battle animation respectively corresponding to each of the n battle regions, wherein a battle animation corresponding to the i^{th} battle region comprises an animation of battling between the at least one first virtual character corresponding to the i^{th} battle region and the at least one second virtual character corresponding to the i^{th} battle region.

18. The computer readable media of claim 1, wherein the instructions, when executed, further configure the data processing system to perform, after the displaying the battle animations:
displaying a battle switching animation when the at least one first virtual character corresponding to the i^{th} battle region satisfies a first battle ending condition, the first battle ending condition being configured for indicating that the at least one first virtual character corresponding to the i^{th} battle region is successful in battling the at least one second virtual character corresponding to the i^{th} battle region, the battle switching animation comprising an animation of switching the at least one first virtual character corresponding to the i^{th} battle region to a j^{th} battle region for battling, where 0<j≤n, and i≠j.

19. A data processing system comprising: a processor, and memory storing computer readable instructions that, when executed by the processor, configure the system to perform:
receiving a battle start operation, the battle start operation being configured for starting a virtual battle, and the virtual battle being a battle between a plurality of first virtual characters and a plurality of second virtual characters;
displaying a battle image of the virtual battle in response to the battle start operation, wherein the battle image comprises n battle regions, wherein n is determined using division based on a depth of field range of the battle image, and wherein each i^{th} battle region comprises at least one first virtual character and at least one second virtual character, where n is an integer greater than 1, and 0<i≤n; and
displaying a battle animation respectively corresponding to each of the n battle regions, wherein a battle animation corresponding to the i^{th} battle region comprises an animation of battling between the at least one first virtual character corresponding to the i^{th} battle region and the at least one second virtual character corresponding to the i^{th} battle region.

20. The system of claim 19, wherein the instructions, when executed, further configure the data processing system to perform, after the displaying the battle animations:
displaying a battle switching animation when the at least one first virtual character corresponding to the i^{th} battle region satisfies a first battle ending condition, the first battle ending condition being configured for indicating that the at least one first virtual character corresponding to the i^{th} battle region is successful in battling the at least one second virtual character corresponding to the i^{th} battle region, the battle switching animation comprising an animation of switching the at least one first virtual character corresponding to the i^{th} battle region to a j^{th} battle region for battling, where 0<j≤n, and i≠j.
